(19) United States
(12) Patent Application Publication
(10) Pub. No.: US 2026/0226304 A1
(43) Pub. Date: Aug. 6, 2026

(54) CLEAR INK FOR INKJET TEXTILE PRINTING, INK SET CONTAINING SAID INK, AND IMAGE PRINTED ITEM

(71) Applicant: NIPPON SHOKUBAI CO., LTD., Osaka (JP)

(72) Inventors: Hiroto IMIYA, Suita-shi, Osaka (JP); Tatsuhiko AKIYAMA, Suita-shi, Osaka (JP); Keiichi NAKAMOTO, Suita-shi, Osaka (JP); Naoki KATAKURA, Suita-shi, Osaka (JP)

(73) Assignee: NIPPON SHOKUBAI CO., LTD., Osaka (JP)

(21) Appl. No.: 19/158,302

(22) PCT Filed: Jan. 17, 2024
(86) PCT No.: PCT/JP2024/001069

§ 371 Date: Aug. 20, 2025

(30) Foreign Application Priority Data
Feb. 20, 2023 (JP) 2023-024440
Feb. 24, 2023 (JP) 2023-027251

(51) Int. Cl. C09D 11/54; C09D 11/40; D06P 1/52; D06P 1/90; D06P 5/00; D06P 5/30

(52) U.S. Cl. CPC C09D 11/54; C09D 11/40; D06P 1/525; D06P 1/90; D06P 5/002; D06P 5/30

(57) ABSTRACT

Provided is a clear ink for inkjet textile printing containing resin emulsion particles, an oxazoline group-containing compound, and an aqueous medium, in which an average particle size of the resin emulsion particles is 150 nm or more, and a content of the oxazoline group-containing compound is 0.5 mass % to 70 mass % with respect to 100 mass % of the resin emulsion particles, and the like.

### TECHNICAL FIELD

The present invention relates to a clear ink for inkjet textile printing, an ink set containing the ink, and an image printed item.

### BACKGROUND ART

In recent years, a textile printing method using an inkjet method with a color ink containing a pigment as a colorant (method for obtaining a textile printed item by inkjet printing) has attracted attention. An ink for inkjet textile printing, which is for use in the textile printing method using the inkjet method, is required to have performance peculiar to the inkjet printing method, such as a dispersion stability, an ejection stability, and fixability to media, as well as a storage stability. An image printed item having images formed by printing color inks on fabrics is required to have performance such as fastness, such as fastness to rubbing and fastness to washing, of the images, as well as not degrading texture of the fabric. Under these circumstances, a clear ink for inkjet textile printing has been proposed, which is used as a base layer or the like for a color ink layer formed by printing a color ink for inkjet textile printing on a part or the whole of the fabric.

An object of Patent Literature 1 is to provide a clear ink capable of forming a coating film having excellent abrasion resistance, and Patent Literature 1 describes a clear ink containing resin particles and water, in which a volume average particle size of the resin particles is 50 nm or less, and a dried film of the clear ink has a glass transition point (Tg) of 50° C. or higher and lower than 0° C.

An object of Patent Literature 2 is to provide a clear ink composition for inkjet textile printing, which is capable of improving fastness to rubbing without degrading texture of a fabric, and Patent Literature 2 describes a clear ink composition for inkjet textile printing containing resin particles, a lubricant, and water, in which a resin in the resin particles includes an urethane resin having a cross-linking group, and a dried coating film of the clear ink composition has a Young's modulus of 5 MPa to 70 MPa.

### CITATION LIST

### Patent Literature

Patent Literature 1: JP2021-95552A
Patent Literature 2: JP7073809B

### SUMMARY OF INVENTION

### Technical Problem

Objects of the present invention are to provide a clear ink for inkjet textile printing that can be used, for example, as a base for a color ink layer in a textile printing method using an inkjet method to provide an image printed item with excellent performance such as texture and fastness, such as fastness to rubbing and fastness to washing, and also has an excellent storage stability as an ink and an excellent ejection stability during printing, to provide an ink set containing the clear ink and a color ink for inkjet textile printing, and an image printed item with excellent performance such as texture and fastness, such as fastness to rubbing and fastness to washing.

### Solution to Problem

The present inventors have focused on the above problems, and as a result of intensive research, the present inventors have found that it is possible to provide a clear ink for inkjet textile printing containing resin emulsion particles and an aqueous medium, in which by setting a particle size of the resin emulsion particles to a specific range and blending a specific amount of a specific compound and, even if a heating temperature during inkjet textile printing is low, by using the clear ink for inkjet textile printing, for example, as a base for a color ink layer or the like, the clear ink can provide an image printed item having excellent performance such as texture and fastness, such as fastness to rubbing and fastness to washing, and has an excellent storage stability as an ink and an excellent ejection stability during printing, and it is possible to provide an ink set containing the clear ink and a color ink for inkjet textile printing, and an image printed item having excellent performance such as texture and fastness, such as fastness to rubbing and fastness to washing, and have completed the present invention.

That is, the clear ink for inkjet textile printing of the present invention is a clear ink for inkjet textile printing containing: resin emulsion particles; an oxazoline group-containing compound; and an aqueous medium, in which an average particle size of the resin emulsion particles is 150 nm or more, and a content of the oxazoline group-containing compound is 0.5 mass % to 70 mass % with respect to 100 mass % of the resin emulsion particles.

An ink set for inkjet textile printing of the present invention includes: the clear ink for inkjet textile printing; and a color ink for inkjet textile printing that contains a pigment, resin emulsion particles, and an aqueous medium.

Further, an image printed item of the present invention includes a fabric; and an image including: a clear ink layer formed by printing the clear ink in the ink set for inkjet textile printing on a part or the whole of the fabric; and a color ink layer formed by printing the color ink in the ink set for inkjet textile printing on a part or the whole of the fabric. The above clear ink layer and the above color ink layer are preferably formed in this order on the fabric.

### Advantageous Effects of Invention

According to the clear ink for inkjet textile printing of the present invention, it is possible to provide a clear ink for inkjet textile printing which is used, for example, as a base for a color ink layer to be able to provide an image printed item having excellent performance such as texture and fastness, such as fastness to rubbing and fastness to washing, and which has an excellent storage stability as an ink and an excellent ejection stability during printing.

According to the ink set for inkjet textile printing of the present invention, it is possible to provide an ink set for inkjet textile printing which is able to provide an image printed item having excellent performance such as texture and fastness, such as fastness to rubbing and fastness to washing, and which has an excellent storage stability as an ink and an excellent ejection stability during printing.

According to the image printed item of the present invention, it is possible to provide an image printed item which has excellent performance such as texture and fastness, such as fastness to rubbing and fastness to washing.

### DESCRIPTION OF EMBODIMENTS

The present invention will be described in detail below. It should be noted that a combination of two or more of individual preferred embodiments of the present invention described below is also a preferred embodiment of the present invention.

In the present specification, “(meth)acrylate” means “acrylate” or “methacrylate”, and “(meth)acrylic” means “acrylic” or “methacrylic”. In addition, (meth)acrylate may also be referred to as (meth)acrylic acid ester.

In addition, in the present specification, “heating temperature during inkjet textile printing” means a heating temperature in a drying processing performed during or after ink printing with an inkjet device (inkjet printer) in a textile printing method using the inkjet device. However, if the ink printing is performed with the inkjet device while a fabric is being heated, that is, if the drying processing is performed during the ink printing and not after the ink printing, the “heating temperature during inkjet textile printing” means the heating temperature in the drying processing when performing the ink printing, and if the ink printing is performed with the inkjet device while the fabric is being heated and heating is also performed after the ink printing, the “heating temperature during inkjet textile printing” means a higher one of a heating temperature during the ink printing and a heating temperature after the ink printing.

In the present specification, the printing refers to applying an ink for inkjet textile printing to a fabric by using an inkjet printer to form an ink layer. In this case, the presence or absence of the drying processing does not matter. When the ink contains a pigment, an image printed item having any image such as a character, a picture, or a diagram can be obtained.

### 1. Clear Ink for Inkjet Textile Printing

A clear ink for inkjet textile printing (hereinafter, also simply referred to as a clear ink) of the present invention is a clear ink containing: resin emulsion particles; an oxazoline group-containing compound; and an aqueous medium, in which an average particle size of the resin emulsion particles is 150 nm or more, and a content of the oxazoline group-containing compound is 0.5 mass % to 70 mass % with respect to 100 mass % of the resin emulsion particles.

The clear ink is an ink that does not substantially contain coloring materials such as pigments, and that forms a colorless, transparent coating after drying. The phrase “does not substantially contain coloring materials” means that the content of the coloring materials in the clear ink is preferably 0.5 mass % or less, and the coloring materials may be contained as long as the coloring materials are present at the level of impurities. In the present specification, the description of “colorless and transparent” means that a parallel transmittance of visible light in the coating film after drying is preferably 30% or more, and more preferably 50% or more.

The parallel transmittance of visible light of the coating film having a thickness of 10 μm obtained by applying the clear ink of the present invention is preferably 30% or more, more preferably 50% or more, and furthermore preferably 80% or more.

A method for measuring the parallel transmittance includes the following methods.

The clear ink is applied to a colorless and transparent glass plate, and is heated and dried at 150° C. for 10 minutes to obtain a glass plate on which a coating film having a thickness of 10 μm is formed.

As the glass plate, a float glass plate (thickness 2 mm) in accordance with JIS R3202 is used.

The glass plate on which the coating film obtained as described above is formed is used as a measurement sample, and a spectral transmittance in a visible region is measured using a spectrophotometer (without using an integrating sphere).

According to the obtained spectral transmittance curve, a simple average of transmittances (parallel transmittances) of wavelengths (every 1 nm) from 400 nm to 780 nm is calculated, and the obtained value is an average transmittance of visible light of the coating film.

The spectrophotometer is not particularly limited, and a commercially available spectrophotometer can be used, and a UV-3600 ultraviolet-visible-near-infrared spectrophotometer manufactured by Shimadzu Corporation is preferred.

The clear ink of the present invention does not substantially contain the coloring material such as a pigment, and therefore stiffness caused by the coloring material is prevented, and by using the clear ink as a base for a color ink layer formed by printing a color ink separately, an image printed item that has both fastness, such as fastness to rubbing and fastness to washing, and a good texture can be provided. In addition, since the coating film after drying is colorless and transparent, the color of the fabric can be utilized.

### <Resin Emulsion Particles>

The resin emulsion particles contained in the clear ink of the present invention are not particularly limited, but a resin particle derived from an aqueous emulsion is preferred.

A shape of the resin emulsion particles is not particularly limited, but is usually spherical. The shape can be measured by a transmission electron microscope or a scanning electron microscope.

An average particle size of the resin emulsion particles can be a value obtained by a cumulant method when measurement is performed using a particle size distribution measuring device (manufactured by Otsuka Electronics Co., Ltd., product number: FPAR-1000) based on a dynamic light scattering method.

The average particle size of the resin emulsion particles is 150 nm or more. By setting the average particle size to 150 nm or more, it becomes easy to blend the resin emulsion particles at a high concentration while keeping a viscosity of the clear ink within an appropriate range. It is also effective in ensuring a storage stability and an ejection stability of the ink. The average particle size is preferably 170 nm or more, more preferably 180 nm or more, and furthermore preferably 190 nm or more. On the other hand, an upper limit is not particularly limited, but is preferably 350 nm or less, more preferably 330 nm or less, and furthermore preferably 310 nm or less.

A glass transition temperature of the resin emulsion particles is not particularly limited, but is preferably 0° C. or lower from a viewpoint that a texture of a textile printed item obtained by using the clear ink of the present invention is likely to be more excellent. More preferably, the glass transition temperature is −10° C. or lower, and furthermore preferably −15° C. or lower. On the other hand, a lower limit is not particularly limited, but is preferably −50° C. or higher, and more preferably −40° C. or higher.

The glass transition temperature may be a value measured by any of differential scanning calorimetry analysis (DSC), differential thermal analysis (DTA), and thermomechanical analysis (TMA), but the glass transition temperature is preferably a value obtained by differential scanning calorimetry (DSC), and unless otherwise specified, the glass transition temperature in the present specification refers to a value obtained by differential scanning calorimetry (DSC). However, when the glass transition temperature can be calculated by using a Fox formula based on a composition of a resin component in the resin emulsion particles described later, such as a vinyl-based resin, a (meth)acrylic-based resin, and an acrylic-styrene-based polymer, this can be used instead.

Examples of a differential scanning calorimetry measuring device include a device manufactured by Seiko Instruments Inc. and having a product number of DSC220C. When measuring the differential scanning calorimetry, there is no particular limitation on a method of drawing a differential scanning calorimetry (DSC) curve, a method of obtaining a first differential curve from a differential scanning calorimetry (DSC) curve, a method of performing a smoothing process, a method of obtaining a target peak temperature, and the like. For example, when the above measuring device is used, a graph may be drawn from data obtained by using the measuring device. In this case, analysis software capable of performing a mathematical process may be used. Examples of the analysis software include analysis software (manufactured by Seiko Instruments Inc., product number: EXSTAR6000). Measurement conditions may preferably include a temperature rise rate of 15° C./min and a temperature fall rate of 15° C./min, and values obtained under these conditions may be used. In the above measurement, a start temperature, an intermediate temperature, an inflection point temperature, and an end temperature for glass transition are observed, and the intermediate temperature is taken as the glass transition temperature (Tg) of the resin emulsion particles.

The Fox formula is as follows.

$$1 / Tg = Σ ( Wm / Tgm ) / 100$$

In the formula, Tg represents the glass transition temperature, Wm represents a content (mass %) of a monomer m in monomer components constituting the resin component, and Tgm represents a glass transition temperature (absolute temperature: K) of a homopolymer of the monomer m.

The glass transition temperature can be calculated by substituting the content of each monomer with respect to a total amount of monomers used to form the resin constituting the resin emulsion particles and the glass transition temperature of the homopolymer of each monomer into the above formula. The glass transition temperature of the homopolymer is, for example, 95° C. for a homopolymer of acrylic acid, 130° C. for a homopolymer of methacrylic acid, 105° C. for a homopolymer of methyl methacrylate, 100° C. for a homopolymer of styrene, 83° C. for a homopolymer of cyclohexyl methacrylate, 20° C. for a homopolymer of n-butyl methacrylate, −70° C. for a homopolymer of 2-ethylhexyl acrylate, −56° C. for a homopolymer of n-butyl acrylate, 55° C. for a homopolymer of hydroxyethyl methacrylate, 165° C. for a homopolymer of acrylamide, and 130° C. for a homopolymer of 4-methacryloyloxy-1,2,2,6,6-pentamethylpiperidine.

The above resin emulsion particles preferably have an acidic functional group. Among acidic functional groups, a carboxy group (—COOH) is preferred. A content of the acidic functional group is preferably 0.06 mass % to 3 mass % with respect to 100 mass % of the resin emulsion particles. The content of the acidic functional group is preferably 0.1 mass % to 5 mass % when the content of the acidic functional group is expressed as a content of a structural unit derived from the monomer having the acidic functional group with respect to 100 mass % of the resin emulsion particles. A preferred content of a carboxy group is the same as that of the above acidic functional group. The resin emulsion particles have the acidic functional group, so that fastness can be further improved.

By setting the content of the carboxy group and the content of the acidic functional group in the resin emulsion particles within the above ranges, when the clear ink is used, uniformity of the formed clear ink layer can be further improved, and for example, even if a heating temperature during inkjet textile printing is low, fastness to washing of an image including the clear ink layer and a color ink layer can be further improved. The content of the acidic functional group such as a carboxy group in the resin emulsion particles can be regulated, for example, by adjusting the composition of the monomers used in the polymerization of the resin emulsion particles.

An acid value of the resin emulsion particles is preferably 0.5 mgKOH/g to 50 mgKOH/g. More preferably, the acid value is 0.8 mgKOH/g to 40 mgKOH/g. A preferred range of an acid value derived from the carboxy group in the resin emulsion particles is the same as that of the above acid value. By setting the acid value of the resin emulsion particles and the acid value derived from the carboxy group in the above ranges, the uniformity of the clear ink layer formed using the clear ink of the present invention can be further improved, and for example, even if the heating temperature during the inkjet textile printing is low (for example, 110° C. or lower), the fastness to washing of the image including the clear ink layer and the color ink layer can be further improved.

From a viewpoint of further improving water resistance and adhesion, a weight average molecular weight of the resin component constituting the above resin emulsion particle is preferably 50000 or more, more preferably 300000 or more, furthermore preferably 550000 or more, and even more preferably 600000 or more. The weight average molecular weight is particularly preferably more than 700000, and most preferably 720000 or more. From a viewpoint of further improving film-forming property and the water resistance, an upper limit of the weight average molecular weight of the resin component is preferably 5000000 or less.

The above weight average molecular weight means a weight average molecular weight (in terms of polystyrene) measured using gel permeation chromatography (manufactured by Tosoh Corporation, product number: HLC-8120GPC, column: TSKgel G-5000HXL and TSKgel GMHXL-L used in series).

A structure of the above resin emulsion particle is not particularly limited, and the particle may have a uniform composition as a whole, or may have a core-shell structure consisting of a core and a shell having different compositions and/or physical properties. The core-shell structure is not limited to two layers, and may have three or more layers. Among these, a core-shell structure having two or more layers is preferred, which can further improve a balance between elongation and hardness of the coating film.

### <Surfactant>

The above resin emulsion particle is preferably dispersed and stabilized in the clear ink by a surfactant. Examples of the surfactant include a nonionic surfactant, an anionic surfactant, a cationic surfactant, and an amphoteric surfactant, and a well-known surfactant in the related art may be used. These surfactants may be used alone or in combination of two or more.

Among the above surfactants, the nonionic surfactant or the anionic surfactant is preferred. A surfactant containing a polymerizable group in a molecule is also preferred. Examples of the polymerizable group include a group having an ethylenically unsaturated double bond. Among the above surfactants, a nonionic surfactant containing the polymerizable group or an anionic surfactant containing the polymerizable group is particularly preferred. A surfactant containing the polymerizable group is also referred to as a reactive emulsifier. A polymeric emulsifier may also be used as the surfactant.

Examples of the anionic surfactant include, but are not limited to, alkyl sulfate salts such as ammonium dodecyl sulfate and sodium dodecyl sulfate; alkyl sulfonate salts such as ammonium dodecyl sulfonate, sodium dodecyl sulfonate, and sodium alkyl diphenyl ether disulfonate; alkylaryl sulfonate salts such as ammonium dodecyl benzene sulfonate and sodium dodecyl naphthalene sulfonate; polyoxyethylene alkyl sulfonate salts; polyoxyethylene alkyl sulfate salts; polyoxyethylene alkylaryl sulfate salts; dialkyl sulfosuccinate salts; arylsulfonic acid-formaldehyde condensates; fatty acid salts such as ammonium laurate and sodium stearylate; sulfuric acid esters having an allyl group or salts thereof such as bis(polyoxyethylene polycyclic phenyl ether) methacrylate sulfonate salts, propenyl-alkyl sulfosuccinate salts, (meth)acrylic acid polyoxyethylene sulfonate salts, (meth)acrylic acid polyoxyethylene phosphonate salts, and sulfonate salts of allyloxymethyl alkyloxy polyoxyethylene; sulfuric acid ester salts of allyloxymethyl alkoxyethyl polyoxyethylene, and polyoxyalkylene alkenyl ether ammonium sulfate.

Examples of the nonionic surfactant include, but are not limited to, polyoxyethylene alkyl ethers, polyoxyethylene alkylaryl ethers, condensates of polyethylene glycol and polypropylene glycol, sorbitan fatty acid esters, polyoxyethylene sorbitan fatty acid esters, fatty acid monoglycerides, condensates of ethylene oxide and aliphatic amines, and polyoxyalkylene alkenyl ethers.

Examples of the cationic surfactant include, but are not limited to, alkyl ammonium salts such as dodecyl ammonium chloride. Examples of the amphoteric surfactant include, but are not limited to, betaine ester-type emulsifiers.

Examples of the polymeric emulsifier include, but are not limited to, poly(meth)acrylates such as sodium polyacrylate; polyvinyl alcohol; polyvinyl pyrrolidone; polyhydroxyalkyl (meth)acrylates such as polyhydroxyethyl acrylate; and copolymers containing one or more types of the monomers constituting these polymers as copolymerization components.

Examples of the reactive emulsifier include, but are not limited to, propenyl-alkyl sulfosuccinate salts, (meth)acrylic acid polyoxyethylene sulfonate salts, (meth)acrylic acid polyoxyethylene phosphonate salts (for example, manufactured by Sanyo Chemical Industries, Ltd., trade name: ELEMINOL RS-30), polyoxyethylene alkylpropenyl phenyl ether sulfonate salts (for example, manufactured by Daiichi Kogyo Seiyaku Co., Ltd., trade name: Aqualon HS-10), sulfonate salts of allyloxymethyl alkyloxy polyoxyethylene (for example, manufactured by Daiichi Kogyo Seiyaku Co., Ltd., trade name: Aqualon KH-10), polyoxyethylene styrenated propenyl phenyl ether sulfuric acid ester ammonium (for example, manufactured by Daiichi Kogyo Seiyaku Co., Ltd., trade name: Aqualon AR-10), polyoxyethylene styrenated propenyl phenyl ether (for example, manufactured by Daiichi Kogyo Seiyaku Co., Ltd., trade name: Aqualon AN-10), sulfonate salts of allyloxymethylnonylphenoxyethylhydroxypolyoxyethylene (for example, manufactured by ADEKA Corporation, trade name: ADEKA REASOAP SE-10), allyloxymethylalkoxyethylhydroxypolyoxyethylene sulfuric acid ester salts (for example, manufactured by ADEKA Corporation, product names: ADEKA REASOAP SR-10 and SR-30), bis(polyoxyethylene polycyclic phenyl ether) methacrylated sulfonate salts (for example, manufactured by Nippon Nyukazai Co., Ltd., trade name: Antox MS-60), allyloxymethylalkoxyethylhydroxypolyoxyethylene (for example, manufactured by ADEKA Corporation, trade name: ADEKA REASOAP ER-20), polyoxyethylene alkylpropenyl phenyl ether (for example, manufactured by Daiichi Kogyo Seiyaku Co., Ltd., trade name: Aqualon RN-20), allyloxymethylnonylphenoxyethyl hydroxypolyoxyethylene (for example, manufactured by ADEKA Corporation, trade name: ADEKA REASOAP NE-10).

The resin constituting the above resin emulsion particle is not particularly limited, and examples thereof include vinyl-based resins, (meth)acrylic-based resins, olefin-based resins, urethane-based resins, fluorine-based resins, silicone-based resins, epoxy resins, phenoxy resins, phenol resins, and xylene resins. Among these, a polymer obtained by polymerizing an ethylenically unsaturated double bond-containing monomer is preferred. In other words, a polymer containing a structural unit derived from an ethylenically unsaturated double bond-containing monomer is preferred. When the resin is a polymer obtained by polymerizing an ethylenically unsaturated double bond-containing monomer, the content of the acidic functional group, such as a carboxy group, and a hydrophobic monomer can be freely designed.

Examples of the ethylenically unsaturated double bond-containing monomer include vinyl-based monomers such as vinyl acetate, vinyl chloride, acrylonitrile, acrylamide, and vinyl benzoate; (meth)acrylic-based monomers such as (meth)acrylic acid esters and (meth)acrylic acid; styrene-based monomers such as styrene, α-methylstyrene, and chloromethylstyrene; olefin-based monomers such as ethylene and propylene; and maleic acid, fumaric acid, crotonic acid, itaconic acid, citraconic acid, maleic anhydride, maleic acid monomethyl ester, maleic acid monobutyl ester, itaconic acid monomethyl ester, and itaconic acid monobutyl ester.

The resin constituting the resin emulsion particles is preferably a (co)polymer obtained by (co)polymerizing one or two or more types of these monomers.

Examples include a vinyl acetate polymer, a vinyl chloride polymer, an ethylene-vinyl acetate copolymer, polystyrene, a styrene-acrylonitrile copolymer, a styrene-butadiene copolymer, an acrylonitrile-butadiene-styrene copolymer, an acrylonitrile-ethylene-styrene copolymer, an acrylonitrile-chlorinated ethylene-styrene copolymer, polyethylene, polypropylene, an ethylene-propylene copolymer, an ethylene-vinyl acetate-(meth)acrylic acid ester copolymer, a (meth)acrylic acid ester (co)polymer, a (meth)acrylic acid ester-(meth)acrylic acid copolymer, a (meth)acrylic acid ester-styrene copolymer, a (meth)acrylic acid ester-(meth)acrylic acid-styrene copolymer, an ethylene-vinyl acetate-(meth)acrylic acid ester copolymer, a (meth)acrylic acid ester-urethane copolymer, and an acrylonitrile-(meth)acrylic acid ester-styrene copolymer.

Among these, from a viewpoint of easily obtaining a textile printed item having not only more excellent fastness to rubbing but also more excellent texture due to high water resistance, a copolymer obtained by copolymerizing a monomer composition containing one or two or more types of the (meth)acrylic-based monomers and one or two or more types of the styrene-based monomers as the ethylenically unsaturated double bond-containing monomer is preferred. Such a copolymer is also referred to as an acrylic-styrene-based polymer. Examples of the above acrylic-styrene-based polymer include a (meth)acrylic acid ester-styrene copolymer, a (meth)acrylic acid ester-(meth)acrylic acid-styrene copolymer, and an acrylonitrile-(meth)acrylic acid ester-styrene copolymer.

The monomers for forming the acrylic-styrene-based polymer may contain monomers other than the (meth)acrylic-based monomer and the styrene-based monomer. A total content of the (meth)acrylic-based monomer and the styrene-based monomer with respect to the total 100 mass % of the monomers for forming the acrylic-styrene-based polymer is preferably 50 mass % or more, more preferably 80 mass % or more, furthermore preferably 95 mass % or more, and particularly preferably 100 mass %.

In other words, the above acrylic-styrene-based polymer may contain a structural unit derived from a (meth)acrylic-based monomer and a structural unit derived from a styrene-based monomer, and may contain structural units other than these structural units. A total content of the structural unit derived from the (meth)acrylic-based monomer and the structural unit derived from the styrene-based monomer with respect to the total 100 mass % of the structural unit constituting the acrylic-styrene-based polymer is preferably 50 mass % or more, more preferably 80 mass % or more, furthermore preferably 95 mass % or more, and particularly preferably 100 mass %.

As the (meth)acrylic-based monomer, one or two or more selected from well-known (meth)acrylic acid esters and (meth)acrylic acids in the related art may be used.

Examples of the (meth)acrylic acid esters include alkyl (meth)acrylates such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, sec-butyl (meth)acrylate, 2-ethylhexyl (meth)acrylate, n-octyl (meth)acrylate, tridecyl (meth)acrylate, cyclohexyl (meth)acrylate, n-lauryl (meth)acrylate, dodecyl (meth)acrylate, stearyl (meth)acrylate, and isobornyl (meth)acrylate; fluoroalkyl (meth)acrylates such as trifluoroethyl (meth)acrylate, tetrafluoropropyl (meth)acrylate, and octafluoropentyl (meth)acrylate; aralkyl (meth)acrylates such as benzyl (meth)acrylate, phenylethyl (meth)acrylate, methylbenzyl (meth)acrylate, and naphthylmethyl (meth)acrylate; hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; epoxy group-containing (meth)acrylates such as glycidyl (meth)acrylate and α-methylglycidyl (meth)acrylate; alkoxyalkyl group-containing (meth)acrylates such as methoxyethyl (meth)acrylate, methoxybutyl (meth)acrylate, ethoxybutyl (meth)acrylate, and trimethylolpropane tripropoxy (meth)acrylate; silyl group-containing (meth)acrylates such as γ-(meth)acryloyloxypropyltrimethoxysilane, γ-(meth)acryloyloxypropylhydroxysilane, and γ-(meth)acryloyloxypropylmethylhydroxysilane; carbonyl group-containing (meth)acrylates such as (meth)acryloxyalkylpropenal, acetonyl (meth)acrylate, diacetone (meth)acrylate, 2-hydroxypropyl (meth)acrylate acetylacetate, butanediol-1,4-acrylate acetylacetate, and 2-(acetoacetoxy)ethyl (meth)acrylate; aziridinyl group-containing (meth)acrylates such as (meth)acryloylaziridine and 2-aziridinylethyl (meth)acrylic acid; oxo group-containing (meth)acrylates such as (di)ethylene glycol (methoxy) (meth)acrylates, such as ethylene glycol (meth)acrylate, ethylene glycol methoxy(meth)acrylate, diethylene glycol (meth)acrylate, and diethylene glycol methoxy(meth)acrylate; and piperidine group-containing (meth)acrylates such as 4-(meth)acryloyloxy-2,2,6,6-tetramethylpiperidine and 4-(meth)acryloyloxy-1,2,2,6,6-pentamethylpiperidine, and one or two or more types thereof may be selected and used.

Furthermore, as the (meth)acrylic acid ester, a polyfunctional (meth)acrylate may also be used. Examples of the polyfunctional (meth)acrylate include di(meth)acrylates of polyhydric alcohols having 1 to 10 carbon atoms such as ethylene glycol di(meth)acrylate, propylene glycol di(meth)acrylate, 1,3-butanediol di(meth)acrylate, 1,4-butanediol di(meth)acrylate, 1,6-hexanediol di(meth)acrylate, ethylene oxide modified 1,6-hexanediol di(meth)acrylate, 1,9-nonanediol di(meth)acrylate, propylene oxide modified neopentyl glycol di(meth)acrylate, and tripropylene glycol di(meth)acrylate; alkyl di(meth)acrylates having 2 to 50 addition moles of an alkylene oxide group having 2 to 4 carbon atoms, such as polyethylene glycol di(meth)acrylate having 2 to 50 addition moles of ethylene oxide, polypropylene glycol di(meth)acrylate having 2 to 50 addition moles of propylene oxide, and tripropylene glycol di(meth)acrylate; tri(meth)acrylates of polyhydric alcohols having 1 to 10 carbon atoms, such as ethoxylated glycerin tri(meth)acrylate, propylene oxide modified glycerol tri(meth)acrylate, ethylene oxide modified trimethylolpropane tri(meth)acrylate, trimethylolpropane tri(meth)acrylate, pentaerythritol monohydroxy tri(meth)acrylate, and trimethylolpropane triethoxy tri(meth)acrylate; tetra(meth)acrylates of polyhydric alcohols having 1 to 10 carbon atoms, such as pentaerythritol tetra(meth)acrylate, dipentaerythritol tetra(meth)acrylate, and ditrimethylolpropane tetra(meth)acrylate; penta(meth)acrylates of polyhydric alcohols having 1 to 10 carbon atoms, such as pentaerythritol penta(meth)acrylate and dipentaerythritol (monohydroxy)penta(meth)acrylate; hexa(meth)acrylates of polyhydric alcohols having 1 to 10 carbon atoms, such as pentaerythritol hexa(meth)acrylate; epoxy group-containing (meth)acrylates such as bisphenol A di(meth)acrylate, 2-(2′-vinyloxyethoxyethyl)(meth)acrylate, and epoxy (meth)acrylate; and urethane (meth)acrylate.

As the (meth)acrylic acid, acrylic acid and methacrylic acid are preferred.

Examples of the above styrene-based monomer include styrene, α-methylstyrene, p-methylstyrene, tert-methylstyrene, chlorostyrene, vinyltoluene, and 2-styrylethyltrimethoxysilane. The styrene-based monomer may have a functional group such as an alkyl group such as a methyl group or a tert-butyl group, a nitro group, a nitrile group, an alkoxyl group, an acyl group, a sulfone group, a hydroxyl group, or a halogen atom on a benzene ring. Among the styrene-based monomers, styrene is preferred from a viewpoint of improving the water resistance.

As the above styrene-based monomer, a polyfunctional styrene-based monomer may also be used. A preferred example of the polyfunctional styrene-based monomer is divinylbenzene.

A content of the styrene-based monomer in the monomers for forming the acrylic-styrene-based polymer is preferably 1 mass % to 55 mass %, more preferably 5 mass % to 50 mass %, and furthermore preferably 10 mass % to 45 mass % with respect to 100 mass % of a total amount of the (meth)acrylic-based monomer and the styrene-based monomer. By setting the content of the styrene-based monomer within the above range, it becomes easier to obtain a textile printed item that has more excellent texture or more excellent fastness to washing.

The above acrylic-styrene-based polymer is preferably a polymer obtained by copolymerizing the monomer compositions in which the (meth)acrylic-based monomer and the styrene-based monomer preferably have a composition ratio within the above range.

The acrylic-styrene-based polymer is preferably a polymer having a carboxy group, and a content of the carboxy group is preferably 0.06 mass % to 3 mass % with respect to 100 mass % of the resin emulsion particles. Furthermore, the content of the carboxy group is preferably 0.1 mass % to 5 mass %, expressed as the content of structural units derived from the monomer having a carboxy group with respect to 100 mass % of the resin emulsion particles.

It is also preferred that the above carboxy group is a carboxy group derived from (meth)acrylic acid. Therefore, it is preferred that the structural units derived from (meth)acrylic-based monomer constituting the acrylic-styrene-based polymer contain one or two or more types of structural units derived from (meth)acrylic acid, and more preferably contain one or two or more types of structural units derived from the (meth)acrylate ester and one or two or more types of structural units derived from (meth)acrylic acid.

A content of the structural unit derived from the (meth)acrylic acid constituting the acrylic-styrene-based polymer is preferably 0.1 mass % to 5 mass %, more preferably 0.2 mass % to 4 mass %, and furthermore preferably 1 mass % to 3 mass % with respect to 100 mass % of the total amount of the structural unit derived from the (meth)acrylic-based monomer and the structural unit derived from the styrene-based monomer.

The (meth)acrylic-based monomer for forming the above acrylic-styrene-based polymer preferably contains one or two or more types of (meth)acrylic acid, and more preferably contains one or two or more types of (meth)acrylate esters and one or two or more types of (meth)acrylic acid.

A content of the (meth)acrylic acid in the monomers for forming the acrylic-styrene-based polymer is preferably 0.1 mass % to 5 mass %, more preferably 0.2 mass % to 4 mass %, and furthermore preferably 1 mass % to 3 mass % with respect to 100 mass % of the total amount of the (meth)acrylic-based monomer and the styrene-based monomer.

The (meth)acrylic-based monomer for forming the above acrylic-styrene-based polymer preferably contains a (meth)acrylic acid ester in addition to (meth)acrylic acid. Among the (meth)acrylic acid esters, it is preferable to contain one or two or more types of alkyl (meth)acrylates, and it is also preferable to contain one or two or more types of hydroxyalkyl (meth)acrylates. Furthermore, it is more preferable to contain one or two or more types of alkyl (meth)acrylates and one or two or more types of hydroxyalkyl (meth)acrylates.

Among the above alkyl (meth)acrylates, it is preferable to include an alkyl (meth)acrylate having an alkyl group having 1 to 18 carbon atoms, and it is more preferable to include an alkyl (meth)acrylate having an alkyl group having 4 to 12 carbon atoms. In addition, it is also preferable to use two or more types of alkyl (meth)acrylates having different carbon atoms in combination. Examples include a combination of an alkyl (meth)acrylate having 1 to 5 carbon atoms and an alkyl (meth)acrylate having 6 to 18 carbon atoms, a combination of an alkyl (meth)acrylate having 1 carbon atom and an alkyl (meth)acrylate having 8 to 18 carbon atoms, a combination of an alkyl (meth)acrylate having 1 carbon atom, an alkyl (meth)acrylate having 4 to 6 carbon atoms, and an alkyl (meth)acrylate having 8 to 18 carbon atoms, and a combination of an alkyl (meth)acrylate having 2 to 6 carbon atoms and an alkyl (meth)acrylate having 8 to 12 carbon atoms. The hydroxyalkyl (meth)acrylate is more preferably a hydroxyalkyl (meth)acrylate having 1 to 18 carbon atoms in a hydroxyalkyl chain, and furthermore preferably a hydroxyalkyl (meth)acrylate having 2 to 4 carbon atoms.

Note that the monomers for forming the acrylic-styrene-based polymer may contain monomers other than the (meth)acrylic-based monomer and the styrene-based monomer. Examples of the other monomers include acrylonitrile, vinyl acetate, and acrylamide. Examples of the other monomers include an addition-polymerizable oxazoline. Examples of the addition-polymerizable oxazoline include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, and 2-isopropenyl-5-ethyl-2-oxazoline.

The acrylic-styrene-based polymer is preferably one obtained by copolymerizing the above preferred monomers in a preferred ratio, and is preferably a polymer containing structural units derived from the preferred monomers in a ratio corresponding to a preferred monomer blending ratio.

The resin emulsion particles contained in the clear ink of the present invention preferably contains the acrylic-styrene-based polymer as the main resin component (for example, 85 mass % to 100 mass %). Such a particle is also referred to as an acrylic-styrene-based polymer emulsion particle.

Note that regarding the resin emulsion particles contained in the clear ink of the present invention, preferred aspects related to the shape of the particle, the average particle size, the glass transition temperature, the content of the acidic functional group, the content of the carboxy group, the acid value, the weight average molecular weight, the structure of the particle, the surfactant, and the like have been described above, and all of these can be directly applied to the above acrylic-styrene-based polymer emulsion particle.

The above acrylic-styrene-based polymer emulsion particle can be produced by a well-known emulsion polymerization method in the related art. The preferred types, combinations, and blending ratios of monomers used in emulsion polymerization are similar to the preferred aspects described for the monomers for forming the acrylic-styrene-based polymer described above. That is, the acrylic-styrene-based polymer emulsion particle can be produced by emulsion polymerizing monomers including a (meth)acrylic-based monomer, a styrene-based monomer, and other ethylenically unsaturated double bond-containing monomers as necessary in an aqueous medium in the presence of an emulsifier. The emulsifier to be used may also be a well-known emulsifier in the related art. The emulsifier to be used may be the above surfactant, and the preferred aspect is the same as the preferred aspect of the above surfactant.

In addition, in the emulsion obtained by the emulsion polymerization method, the residual monomer is preferably less than 100 ppm by mass with respect to the emulsion. The residual monomer can be measured by gas chromatography or the like. It is preferable to extend aging of the polymerization reaction by adding an additional polymerization initiator such that the residual monomer is less than 100 ppm after the aging.

### <Oxazoline Group-Containing Compound>

The clear ink of the present invention contains an oxazoline group-containing compound. In the present specification, the oxazoline group-containing compound preferably means a compound having two or more oxazoline groups in a molecule. Examples of the above oxazoline group-containing compound include, but are not limited to, 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinylcyclohexane) sulfide, bis(2-oxazolinylnorbornane) sulfide, and oxazoline group-containing polymers. These oxazoline group-containing compounds may be used alone or in combination of two or more types.

The oxazoline group-containing compound may be of a water-soluble type or an emulsion type, and among these, from a viewpoint of excellent crosslinking performance, a water-soluble oxazoline group-containing compound is preferred, and an oxazoline group-containing polymer is also preferred. In this case, even a small amount can further improve the fastness effectively.

The above oxazoline group-containing polymer can be produced by a well-known production method in the related art. Examples include a method of polymerizing one or two or more types of addition-polymerizable oxazolines, or monomer components containing an addition-polymerizable oxazoline and a monomer copolymerizable with the addition-polymerizable oxazoline. As the copolymerizable monomer, a monomer that does not have a functional group reacting with the oxazoline group and is copolymerizable with the addition-polymerizable oxazoline is preferred. Examples include, in the ethylenically unsaturated double bond-containing monomer, a monomer that does not have a functional group reacting with an oxazoline group. Examples include vinyl-based monomers such as vinyl acetate, vinyl chloride, acrylonitrile, acrylamide, and vinyl benzoate; (meth)acrylic-based monomers such as (meth)acrylic acid esters; styrene-based monomers such as styrene, α-methylstyrene, and chloromethylstyrene; and olefin-based monomers such as ethylene and propylene.

Examples of the above addition-polymerizable oxazoline include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, and 2-isopropenyl-5-ethyl-2-oxazoline.

Among the oxazoline group-containing polymers, a water-soluble oxazoline group-containing polymer is preferred, and can be produced by the same method as the above method for producing the oxazoline group-containing polymer. Examples of the above water-soluble oxazoline group-containing polymer include polymers having an acrylic-based polymer, an acrylic-styrene-based polymer, or the like as a main chain and containing an oxazoline group in a side chain.

As the oxazoline group-containing polymer, commercially available products may be used. Examples include water-soluble polymers such as trade names EPOCROS WS-500 and EPOCROS WS-700, and emulsion-type polymers such as trade names EPOCROS K-2010, EPOCROS K-2020, and EPOCROS K-2030 manufactured by Nippon Shokubai Co., Ltd. Among these, water-soluble polymers such as trade names EPOCROS WS-500 and EPOCROS WS-700 manufactured by Nippon Shokubai Co., Ltd. are preferred.

A content of the oxazoline group-containing compound contained in the clear ink of the present invention is 0.5 mass % to 70 mass %, preferably 0.5 mass % to 50 mass %, more preferably 0.5 mass % to 30 mass %, and furthermore preferably 0.5 to 10 mass % with respect to 100 mass % of the resin emulsion particles. The above range is preferred mainly from a viewpoint of fastness to rubbing.

It is presumed that the oxazoline group-containing compound acts as a crosslinker even at low temperatures due to interaction with components contained in the clear ink of the present invention, such as the resin emulsion particles, or through a chemical reaction, to form a tough clear ink layer.

### <Aqueous Medium>

The clear ink of the present invention contains an aqueous medium. In the present invention, the aqueous medium means a solvent containing water. A content of water in the aqueous medium is preferably 10 mass % to 100 mass %. The content is more preferably 25 mass % or more, furthermore preferably 50 mass % or more, and particularly preferably 70 mass % or more. The remainder is preferably an organic solvent.

The above aqueous medium may contain an organic solvent. Examples of the organic solvent include glycols such as propylene glycol, 1,3-propanediol, glycerin, dipropylene glycol, tripropylene glycol, diethylene glycol, triethylene glycol, and tetraethylene glycol; ethers of monoethylene glycol such as monoethylene glycol monomethyl ether, monoethylene glycol monoethyl ether, monoethylene glycol monopropyl ether, monoethylene glycol monoisopropyl ether, monoethylene glycol monobutyl ether, and monoethylene glycol monoisobutyl ether; ethers of monopropylene glycol such as monopropylene glycol monomethyl ether, monopropylene glycol monoethyl ether, monopropylene glycol monopropyl ether, monopropylene glycol monoisopropyl ether, monopropylene glycol monobutyl ether, and monopropylene glycol monoisobutyl ether; ethers of polyethylene glycol such as monomethyl ether of polyethylene glycol (EO addition moles=2 to 10, preferably 2 to 4), monoethyl ether of polyethylene glycol (EO addition moles=2 to 10, preferably 2 to 4), monopropyl ether of polyethylene glycol (EO addition moles=2 to 10, preferably 2 to 4), monoisopropyl ether of polyethylene glycol (EO addition moles=2 to 10, preferably 2 to 4), monobutyl ether of polyethylene glycol (EO addition moles=2 to 10, preferably 2 to 4), monoisobutyl ether of polyethylene glycol (EO addition moles=2 to 10, preferably 2 to 4); ethers of polypropylene glycol such as monomethyl ether of polypropylene glycol (EO addition moles=2 to 10, preferably 2 to 4), monoethyl ether of polypropylene glycol (EO addition moles=2 to 10, preferably 2 to 4), monopropyl ether of polypropylene glycol (EO addition moles=2 to 10, preferably 2 to 4), monoisopropyl ether of polypropylene glycol (EO addition moles=2 to 10, preferably 2 to 4), monobutyl ether of polypropylene glycol (EO addition moles=2 to 10, preferably 2 to 4), monoisobutyl ether of polypropylene glycol (EO addition moles=2 to 10, preferably 2 to 4); and heterocyclic compounds such as 2-pyrrolidone and N-methyl-2-pyrrolidone.

Among these, propylene glycol, glycerin, diethylene glycol, triethylene glycol, diethylene glycol monoisopropyl ether, diethylene glycol monobutyl ether, diethylene glycol monoisobutyl ether, triethylene glycol monobutyl ether, monobutyl ether of polyethylene glycol (EO addition moles=2 to 4), or 2-pyrrolidone is preferred, and propylene glycol, triethylene glycol, monobutyl ether of polyethylene glycol (EO addition moles=2 to 4), or 2-pyrrolidone is more preferred. These organic solvents may be used alone or in combination of two or more types.

### <Composition Ratio>

A content of the resin emulsion particles in the clear ink of the present invention is preferably 10 mass % to 20 mass % with respect to 100 mass % of the clear ink. The above range is preferred from a viewpoint of further improving fastness to rubbing of an image including the clear ink layer and the color ink layer formed by processing at a low temperature during inkjet textile printing, and further improving the ejection stability of the clear ink during printing. More preferably, the content is 10.5 mass % or more and 18 mass % or less.

The content of the aqueous medium in the clear ink of the present invention is preferably 60 mass % to 92 mass % with respect to 100 mass % of the clear ink of the present invention, and more preferably 70 mass % to 90 mass %.

### <Other Components>

The clear ink of the present invention may contain components other than the above essential components (resin emulsion particle, oxazoline group-containing compound, and aqueous medium) within the scope where the object of the present invention is not impeded. For example, additives such as a surfactant, a dispersant, a leveling agent, a UV absorber, a UV stabilizer, a thickener, a wetting agent, a plasticizer, a stabilizer, a defoamer, a dye, an antioxidant, a crosslinking accelerator, a PH adjuster, and a preservative may be contained in an appropriate amount.

As the leveling agent, for example, it is preferable to use an acetylene-based (including acetylene glycol-based), silicone-based, or fluorine-based surfactant, and it is more preferable to use an acetylene-based leveling agent or a silicone-based leveling agent. Furthermore, it is preferable to use an acetylene-based leveling agent and a silicone-based leveling agent in combination. By using an acetylene-based leveling agent and a silicone-based leveling agent in combination, a leveling property of the clear ink is further improved, the fastness is further improved, and the ejection stability is also further improved. As the silicone-based leveling agent, a polyether-modified silicone compound is preferred.

Examples of the acetylene-based leveling agent include Surfynol 104E, Surfynol 104H, Surfynol 104A, Surfynol 104BC, Surfynol 104DPM, Surfynol 104PA, Surfynol 104PG-50, Surfynol 420, and Surfynol 440, which are manufactured by Air Products Co., Ltd., and Olfine D-10A, Olfine D-10PG, Olfine E1004, Olfine E1010, Olfine E1020, Olfine PD-001, Olfine PD-002W, Olfine PD-004, Olfine PD-005, Olfine EXP. 4001, Olfine EXP. 4200, Olfine EXP. 4123, and Olfine EXP. 4300, which are manufactured by Nissin Chemical Industry Co., Ltd. These may be used alone or in combination of two or more types.

Examples of the silicone-based leveling agent include KF-351A, 352A, 353, 354L, 355A, 615A, 945, 640, 642, 643, 644, 6020, 6204, 6011, 6012, 6015, and 6017 (manufactured by Shin Etsu Chemical Co., Ltd.), BYK-345, 347, 348, and 349 (manufactured by BYK Corporation), WET 240, 270, and 280 (manufactured by Evonik Corporation), and SAG014 and 503A (manufactured by Nissin Chemical Industry Co., Ltd.). These may be used alone or in combination of two or more types.

When the leveling agent is used, a using amount thereof is preferably 0.01 mass % to 2 mass %, more preferably 0.05 mass % to 1.5 mass %, and furthermore preferably 0.1 mass % to 1 mass % with respect to 100 mass % of the clear ink of the present invention.

When the acetylene-based leveling agent and the silicone-based leveling agent are used in combination, a content of each is preferably 0.05 mass % to 1.5 mass %, and more preferably 0.1 mass % to 1 mass % with respect to 100 mass % of the clear ink.

A mass ratio of the acetylene-based leveling agent to the silicone-based leveling agent is preferably acetylene-based leveling agent/silicone-based leveling agent=0.1 to 20, more preferably 0.2 to 10, furthermore preferably 0.4 to 8, even more preferably 0.6 to 6, particularly preferably 0.8 to 4, and most preferably 1.2 to 3.

When the above other components are added, a content thereof is not particularly limited, but is preferably 2 mass % or less, and more preferably 1 mass % or less with respect to 100 mass % of the clear ink of the present invention. In addition, in order to exert an effect of the addition, the content is preferably 0.01 mass % or more, and more preferably 0.05 mass % or more.

### <Method for Producing Clear Ink for Inkjet Textile Printing>

A method for producing the clear ink of the present invention is not particularly limited. For example, the clear ink can be produced by mixing the resin emulsion particles, the oxazoline group-containing compound, and the aqueous medium, and a preferred production example will be shown below.

First, an emulsion containing the resin emulsion particles is prepared. The emulsion containing the resin emulsion particles can be produced by the emulsion polymerization method in the related art as described above. The content of the resin emulsion particles in the emulsion is not particularly limited, but is preferably 30 mass % to 65 mass % with respect to 100 mass % of the emulsion. The emulsion obtained by the emulsion polymerization method usually contains an emulsifier such as a surfactant used in the emulsification, but the emulsion may be used as it is as the emulsion for preparing the clear ink of the present invention.

Next, the emulsion, the oxazoline group-containing compound, and the aqueous medium as necessary are mixed. In mixing, the oxazoline group-containing compound may be used as it is, or a solution diluted with an aqueous medium or the like may be used.

In order to adjust a concentration of each component in the clear ink of the present invention or to adjust physical properties of the clear ink, the aqueous medium may be mixed or one of or a mixture of the water and the organic solvent constituting the aqueous medium may be mixed, or other components such as additives in addition to those described above may be further mixed. A timing of mixing these (aqueous medium, additives, and the like) may be appropriately selected. Centrifugation, filtration, and the like may be performed as necessary.

According to the above production method, the clear ink of the present invention is obtained, which contains the resin emulsion particles, the oxazoline group-containing compound, and the aqueous medium, and further contains other components such as additives as necessary.

The clear ink of the present invention can be suitably used for textile printing on a fabric using an inkjet printer.

In the method for producing the clear ink for inkjet textile printing, suitable aspects of the clear ink for inkjet textile printing (for example, the average particle size of the resin emulsion particles and the content of the oxazoline group-containing compound) are each independently the same as the preferred aspects described in the sections on the above clear ink of the present invention.

### 2. Ink Set for Inkjet Textile Printing

An ink set for inkjet textile printing (hereinafter, sometimes simply referred to as an ink set) of the present invention includes the above clear ink of the present invention and a color ink for inkjet textile printing that contains a pigment, resin emulsion particles, and an aqueous medium.

### [Color Ink for Inkjet Textile Printing]

The above color ink for inkjet textile printing (hereinafter, sometimes simply referred to as a color ink) contains the pigment, the resin emulsion particles, and the aqueous medium. The above color ink also includes a white ink.

### <Resin Emulsion Particles>

The average particle size of the resin emulsion particles contained in the color ink is not particularly limited, but is preferably 150 nm or more, more preferably 170 nm or more, furthermore preferably 180 nm or more, and even more preferably 190 nm or more. On the other hand, an upper limit is not particularly limited, but is preferably 350 nm or less, more preferably 330 nm or less, and furthermore preferably 310 nm or less.

Other aspects of the resin emulsion particles are the same as those described in the sections on the clear ink of the present invention above, and preferred aspects are also the same as those described in the section on the above clear ink of the present invention.

The resin emulsion particles contained in the above color ink preferably contain the acrylic-styrene-based polymer as the main resin component (for example, 85 mass % to 100 mass %). Such a particle is also referred to as an acrylic-styrene-based polymer emulsion particle.

It is preferable that the resin emulsion particles in the clear ink and the resin emulsion particles in the color ink of the ink set both contain the acrylic-styrene-based polymer as the main resin component (for example, 85 mass % to 100 mass %).

### <Aqueous Medium>

The aqueous medium is the same as that described in the sections on the above clear ink of the present invention, and preferred aspects are also the same as those described in the section on the above clear ink of the present invention.

### <Pigment>

The above color ink contains a pigment. Examples of the pigment include an organic pigment and an inorganic pigment, which may be used alone or in combination of two or more types. If necessary, these pigments may be used in combination with an extender pigment.

Examples of the organic pigment include an azo pigments such as benzidine and Hansa Yellow, diazo pigments, azomethine pigments, methine pigments, anthraquinone pigments, phthalocyanine pigments such as phthalocyanine blue, perinone pigments, perylene pigments, diketopyrrolopyrrole pigments, thioindigo pigments, iminoisoindoline pigments, isoindolinone pigments such as iminoisoindolinone, dioxazine pigments, quinacridone pigments such as quinacridone red and quinacridone violet, flavanthrone pigments, indanthrone pigments, anthrapyrimidine pigments, carbazole pigments, monoarylide yellow, diarylide yellow, benzimidazolone yellow, tolyl orange, naphthol orange, and quinophthalone pigments.

Hue is not particularly limited, and any chromatic pigment such as yellow, magenta, cyan, blue, red, orange, and green may be used, and specific examples include products with product numbers such as C.I. Pigment Yellow, C.I. Pigment Red, C.I. Pigment Orange, C.I. Pigment Violet, C.I. Pigment Blue, and C.I. Pigment Green. When a polypropylene fabric is a target, it is preferable to use organic pigments that do not contain metals so as not to promote thermal decomposition of polypropylene. Specifically, Pigment Blue 16 and the like may be selected.

Examples of the inorganic pigment include colloidal silica, titanium dioxide, antimony trioxide, zinc oxide such as zinc white, lithopone, white lead, red iron oxide, black iron oxide, chromium oxide green, carbon black, yellow lead, molybdenum red, ferric ferrocyanide (Prussian blue), ultramarine, and lead chromate. Examples of the inorganic pigment include flat-shaped pigments such as mica, clay, aluminum powder, talc, and aluminum silicate, and extender pigments such as calcium carbonate, magnesium hydroxide, aluminum hydroxide, barium sulfate, and magnesium carbonate. Examples of carbon black include furnace black, thermal lamp black, acetylene black, and channel black.

Among the inorganic pigments, a preferred white pigment is titanium dioxide, antimony trioxide, zinc oxide such as zinc white, lithopone, white lead, calcium carbonate, magnesium hydroxide, aluminum hydroxide, barium sulfate, magnesium carbonate, clay, talc, or aluminum silicate. Among these, titanium dioxide is preferred from a viewpoint of high refractive index and excellent hiding property. Among titanium dioxides, titanium dioxide having a rutile crystal structure is preferred.

As a color pigment, the above organic pigments, red iron oxide, black iron oxide, chromium oxide green, carbon black, yellow lead, molybdenum red, ferric ferrocyanide (Prussian blue), ultramarine, lead chromate, or the like is preferred.

An average particle size of the pigment is preferably 10 nm to 1000 nm, and preferably 20 nm to 500 nm from a viewpoint of a dispersion stability and a coloring property or hiding power.

In the case of the white pigment, an average particle size is preferably 100 nm to 500 nm, from a viewpoint of a more excellent hiding property, and a lower limit is more preferably 150 nm or more, and furthermore preferably 200 nm or more, and an upper limit is more preferably 450 nm or less, and furthermore preferably 400 nm or less.

In the case of the color pigment, an average particle size is preferably 20 nm to 200 nm especially from a viewpoint of further improving the coloring property, and a lower limit is more preferably 40 nm or more, and furthermore preferably 50 nm or more, and an upper limit is more preferably 150 nm or less, and furthermore preferably 100 nm or less.

Those average particle sizes of the pigments are the average particle sizes in the above color ink. The average particle size of the pigment can be determined with a laser diffraction scattering type particle size distribution analyzer or by a dynamic light scattering method. For example, a value obtained by a cumulant method when measurement is performed using a particle size distribution measuring device (manufactured by Otsuka Electronics Co., Ltd., product number: FPAR-1000) based on a dynamic light scattering method can be used. However, in the case where the measurement based on the dynamic light scattering is difficult as of black pigments and the like, a 50% particle size in the volume-based particle size distribution measured using a laser diffraction scattering type particle size distribution meter can be used as the average particle size.

The pigment is preferably stabilized in the above color ink by a dispersant. Examples of the dispersant include poly(meth)acrylic acid (salts) such as poly(meth)acrylic acid and poly(meth)acrylate salts; copolymers of (meth)acrylic acid (salts) with one or two or more types of ethylenically unsaturated double bond-containing monomers such as (meth)acrylic acid esters, (meth)acrylonitrile, (meth)acrylamide, styrene, maleic acid, maleic anhydride, maleic acid esters, and vinyl acetate; polyvinyl alcohol; and polyvinylpyrrolidone.

The color ink preferably further contains an oxazoline group-containing compound. In this case, in an image printed item, described later, including a clear ink layer formed by printing the above clear ink of the present invention on a part or the whole of a fabric and a color ink layer formed by printing the above color ink on a part or the whole of the fabric, the fastness of the image in the image printed item is further improved. Specific examples of the oxazoline group-containing compound are the same as those described in the section on the clear ink of the present invention.

A content of the oxazoline group-containing compound contained in the color ink is preferably 0.5 mass % to 10 mass % with respect to 100 mass % of the resin emulsion particles. The above range is preferred mainly from a viewpoint of further improving the fastness to rubbing. The above content is more preferably 5 mass % or less.

It is presumed that the oxazoline group-containing compound exhibits a more crosslinking agent-like effect even at low temperatures due to interaction with components contained in the above color ink, such as the resin emulsion particles, the pigment, or a pigment dispersant, or due to the chemical reaction, resulting in an image including a tough clear ink layer and color ink layer.

### <Composition Ratio>

A content of the resin emulsion particles in the above color ink is preferably 10 mass % to 20 mass % with respect to 100 mass % of the above color. The above range is preferred from a viewpoint of further improving the fastness to rubbing of the image including the clear ink layer and the color ink layer formed by processing at a low temperature during inkjet textile printing, and further improving the ejection stability of the color ink during printing. The content of 10.5 mass % or more is more preferable. The content of 18 mass % or less is more preferable.

A content of the pigment in the color ink is not particularly limited, but is preferably 1 mass % to 20 mass % per 100 mass % of the color ink. If the content is less than 1 mass %, there is a risk that the coloring property and the hiding property are insufficient, and if the content exceeds 20 mass %, there is a risk that the texture is deteriorated. The content or 2 mass % or more is more preferrable. The content of 18 mass % or less is more preferable.

The content of the aqueous medium in the above color ink is preferably 55 mass % to 89 mass % and more preferably 70 mass % to 85 mass % with respect to 100 mass % of the color ink.

The content of the pigment in the above color ink with respect to a total content of 100 mass % of the pigment, the resin emulsion particles, and the oxazoline group-containing compound added as necessary is preferably 10 mass % to 80 mass %, and more preferably 15 mass % to 75 mass %, from a viewpoint of further improving the hiding property or the coloring property of the color ink layer formed by printing the color ink on a part or the whole of the fabric.

### <Other Components>

The above color ink may contain other components as necessary in addition to the components described above. Other components are the same as those described above in the section on the clear ink of the present invention, and preferred aspects are also the same as those described above in the section on the clear ink of the present invention.

### [Method for Producing Clear Ink]

In a method for producing the clear ink contained in the ink set of the present invention, suitable aspects of the clear ink (for example, the average particle size of the resin emulsion particles and the content of the oxazoline group-containing compound) are each independently the same as those described in the sections on the clear ink of the present invention above, and preferred aspects are also the same as the preferred aspects described in the section on the clear ink of the present invention above.

### [Method for Producing Color Ink]

A method for producing the above color ink is not particularly limited. For example, the color ink can be produced by mixing the pigment, the resin emulsion particles, the oxazoline group-containing compound added as necessary, and the aqueous medium, and a preferred production example will be shown below.

First, an emulsion containing the resin emulsion particles and a pigment dispersion are each prepared. The above pigment dispersion is preferably one obtained by dispersing a pigment in an aqueous medium. The above pigment dispersion can be produced, for example, by mixing an aqueous medium, such as water, with a pigment and a dispersant and subjecting the mixture to a dispersing treatment with a bead mill or the like. A content of the pigment in the pigment dispersion is not particularly limited, but is preferably 15 mass % to 65 mass % with respect to 100 mass % of the pigment dispersion. On the other hand, an emulsion containing the resin emulsion particles can be produced by the well-known emulsion polymerization method in the related art as described above. The content of the resin emulsion particles in the emulsion is not particularly limited, but is preferably 30 mass % to 65 mass % with respect to 100 mass % of the emulsion. The emulsion obtained by the emulsion polymerization method usually contains an emulsifier such as a surfactant used in the emulsification, but the emulsion may be used as it is as the emulsion for preparing the above color ink.

Next, the above pigment dispersion, the above emulsion, the oxazoline group-containing compound as necessary, and the aqueous medium are mixed. In mixing, when the above oxazoline group-containing compound is mixed, the compound may be used as it is, or a solution diluted with an aqueous medium or the like may be used. Methods for and a sequence of mixing those components are not particularly limited. For example, after the above emulsion and the above pigment dispersion are mixed, the above oxazoline group-containing compound may be mixed, or after the above pigment dispersion and the above oxazoline group-containing compound are mixed, the above emulsion may be mixed, or after the above emulsion and the above oxazoline group-containing compound are mixed, the above pigment dispersion may be mixed, or the above pigment dispersion, the above emulsion, and the above oxazoline group-containing compound may be mixed almost simultaneously.

In order to adjust a concentration of each component in the above color ink or to adjust physical properties of the above color ink, the aqueous medium may be mixed or one of or a mixture of the water and the organic solvent constituting the aqueous medium may be mixed, or other components such as additives other than those described above may be further mixed. A timing of mixing these (aqueous medium, additives, and the like) may be appropriately selected. Centrifugation, filtration, and the like may be performed as necessary.

According to the above production method, the above color ink is obtained, which contains the pigment, the resin emulsion particles, the oxazoline group-containing compound added as necessary, and the aqueous medium, and further contains other components such as additives as necessary.

The ink set of the present invention can be suitably used for textile printing on a fabric using an inkjet printer. By using the ink set of the present invention in the inkjet textile printing method, an image printed item including a fabric and any image such as a character, a pattern, or a figure can be obtained. In this case, according to the above configuration, the ink set of the present invention can preferably provide an image printed item having excellent performance such as texture and fastness, such as fastness to rubbing and fastness to washing, even if the heating temperature during the inkjet textile printing is low. Therefore, by using the ink set of the present invention in inkjet textile printing on fabrics and the like, it is possible to reduce energy consumption in a drying step, and also to form (textile print) a clear ink layer and a color ink layer that have excellent fastness to rubbing even on fabrics that include materials with low heat resistance, such as polypropylene fibers and polyester fibers.

### 3. Image Printed Item

The image printed item of the present invention includes the fabric and the image including the clear ink layer formed by printing the clear ink in the above ink set of the present invention on a part or the whole of the fabric and the color ink layer formed by printing the color ink in the above ink set of the present invention on a part or the whole of the fabric. The clear ink layer is formed by printing the clear ink and then drying the printed clear ink with or without heating. The color ink layer is formed by printing the color ink and then drying the printed color ink with or without heating. The above clear ink layer and the above color ink layer are preferably formed in this order on the fabric. In this case, the fastness of the image printed item can be further improved. At an interface between the above clear ink layer and the above color ink layer, the above clear ink layer and the above color ink layer may be clearly separated, or may not be clearly separated and may be in a partially mixed state.

The clear ink layer preferably contains a resin (R), and the resin (R) preferably contains a reaction product (C) of an acrylic-styrene-based polymer (A) having a carboxy group and an oxazoline group-containing compound (B). The color ink layer preferably contains a pigment and a resin (R′), and the resin (R′) preferably contains a reaction product (C′) of an acrylic-styrene-based polymer (A′) having a carboxy group and an oxazoline group-containing compound (B′).

The reaction products (C) and (C′) are generated even when drying is performed at ordinary temperature without heating at a temperature higher than the room temperature. The higher the temperature, the more the reaction proceeds. When the heating is performed at a temperature higher than the room temperature, the reaction products (C) and (C′) are generated at a higher rate, but it is considered that the reaction product (C) and (C′) are generated little by little over time even when the drying is performed at the ordinary temperature.

Each of the acrylic-styrene-based polymers (A) and (A′) preferably contains a structural unit derived from a (meth)acrylic-based monomer and a structural unit derived from a styrene-based monomer. In addition, structural units other than these structural units may also be contained. A total content of the structural unit derived from the (meth)acrylic-based monomer and the structural unit derived from the styrene-based monomer with respect to the total 100 mass % of the structural units constituting each of the above polymers (A) and (A′) is independently preferably 50 mass % or more, more preferably 80 mass % or more, furthermore preferably 95 mass % or more, and particularly preferably 100 mass %.

A content of the structural unit derived from the styrene-based monomer in each of the above acrylic-styrene-based polymers (A) and (A′) is not particularly limited, but is independently preferably 1 mass % to 55 mass %, more preferably 5 mass % to 50 mass %, and furthermore preferably 10 mass % to 45 mass % with respect to 100 mass % of a total amount of the structural unit derived from the (meth)acrylic-based monomer and the structural unit derived from the styrene-based monomer. By setting the content of the styrene-based monomer within the above range, it becomes easier to obtain an image printed item (for example, textile printed item) that has more excellent texture or more excellent fastness to washing.

A content of the carboxy group in each of the acrylic-styrene-based polymers (A) and (A′) is independently preferably 0.06 mass % to 3 mass % with respect to 100 mass % of each of the acrylic-styrene-based polymers (A) and (A′). It is also preferred that the above carboxy group is a carboxy group derived from (meth)acrylic acid. Therefore, it is more preferable that each of the acrylic-styrene-based polymers (A) and (A′) contains a structural unit derived from (meth)acrylic acid. A content of the structural unit derived from (meth)acrylic acid in each of the acrylic-styrene-based polymers (A) and (A′) is independently preferably 0.1 mass % to 5 mass %, more preferably 0.2 mass % to 4 mass %, and furthermore preferably 1 mass % to 3 mass % with respect to 100 mass % of the total amount of the structural unit derived from the (meth)acrylic-based monomer and the structural unit derived from the styrene-based monomer.

Each of the above acrylic-styrene-based polymers (A) and (A′) further preferably contains a structural unit derived from a (meth)acrylic acid ester. Among these, it is preferable to contain a structural unit derived from an alkyl (meth)acrylate or a structural unit derived from a hydroxyalkyl (meth)acrylate. Furthermore, it is more preferable to contain a structural unit derived from an alkyl (meth)acrylate and a structural unit derived from a hydroxyalkyl (meth)acrylate.

In the structural unit derived from alkyl (meth)acrylate, the alkyl group contained in the structural unit preferably contains an alkyl group having 1 to 18 carbon atoms, and more preferably contains an alkyl group having 4 to 12 carbon atoms. In addition, it is also a preferred aspect that the above alkyl group contains two or more types of alkyl groups having different carbon atoms. Examples include an aspect of containing an alkyl group having 1 to 5 carbon atoms and an alkyl group having 6 to 18 carbon atoms, an aspect of containing an alkyl group having 1 carbon atom and an alkyl group having 8 to 18 carbon atoms, an aspect of containing an alkyl group having 1 carbon atom, an alkyl group having 4 to 6 carbon atoms, and an alkyl group having 8 to 18 carbon atoms, and an aspect of containing an alkyl group having 2 to 6 carbon atoms and an alkyl group having 8 to 12 carbon atoms. In addition, in the structural unit derived from the above hydroxyalkyl (meth)acrylate, a hydroxyalkyl group preferably has 1 to 18 carbon atoms, and more preferably has 2 to 4 carbon atoms.

The structural units in the above acrylic-styrene-based polymers (A) and (A′) may each independently contain a structural unit other than the structural unit derived from the (meth)acrylic-based monomer and the structural unit derived from the styrene-based monomer. Examples of the other structural unit include structural units derived from monomers such as acrylonitrile, vinyl acetate, and acrylamide.

The oxazoline group-containing compounds (B) and (B′) are each independently the same as the above oxazoline group-containing compounds, including preferred aspects, and the above description can be applied mutatis mutandis. Therefore, the description is omitted.

The above reaction product (C) is generated by a reaction of the carboxy group of the acrylic-styrene-based polymer (A) with the oxazoline group of the oxazoline group-containing compound (B). The above reaction product (C′) is generated by a reaction of the carboxy group of the acrylic-styrene-based polymer (A′) with the oxazoline group of the oxazoline group-containing compound (B′). Preferably, each of the above reactions forms an amide ester bond. A content of each of the amide ester bonds is not particularly limited, but is independently 0.05 mass % to 5 mass % with respect to 100 mass % of each of the above resins (R) and (R′). More preferably, the content is 0.1 mass % to 3 mass %. A content of each of the reaction products (C) and (C′) in the resins (R) and (R′) is not particularly limited, but is independently preferably 0.1 mass % to 50 mass % with respect to 100 mass % of each of the resins (R) and (R′). The content is more preferably 0.2 mass % to 40 mass %, and further preferably 0.3 mass % to 30 mass %.

The above resins (R) and (R′) further preferably contain the above acrylic-styrene-based polymers (A) and (A′), respectively, in addition to the above reaction products (C) and (C′), respectively. By containing the acrylic-styrene-based polymers (A) and (A′), the fabric is likely to be more excellent in texture. A content of each of the acrylic-styrene-based polymers (A) and (A′) in the resins (R) and (R′) is independently preferably 50 mass % to 99.9 mass % with respect to 100 mass % of each of the resins (R) and (R′). A lower limit is more preferably 60 mass % or more, and furthermore preferably 70 mass % or more, and an upper limit is more preferably 99.8 mass % or less, furthermore preferably 99.7 mass % or less, and even more preferably 99 mass % or less.

The resins (R) and (R′) may further contain oxazoline group-containing compounds (B) and (B′), respectively. A content of each of the above polymers (B) and (B′) in the resins (R) and (R′) is independently preferably 0 mass % to 5 mass % with respect to 100 mass % of each of the resins (R) and (R′). The content is more preferably 0 mass % to 2 mass %, and furthermore preferably 0 mass % to 1 mass %.

The pigment contained in the above color ink layer is similar to the pigment constituting the color ink, including the preferred aspects, and the above description can be applied mutatis mutandis. Therefore, the description is omitted.

A film thickness of each of the clear ink layer and the color ink layer is not particularly limited, but is independently preferably 0.1 μm to 1000 μm, more preferably 0.3 μm to 500 μm, and furthermore preferably 0.5 μm to 100 μm. The above film thicknesses can be measured, for example, by observation using a laser microscope or the like.

### <Fabric>

The fabric included in the image printed item of the present invention preferably includes all textile products such as cloth and textiles made of natural and/or synthetic fibers. Examples include woven fabrics, nonwoven fabrics, and knitted fabrics. The fibers constituting the fabric are not particularly limited, and examples include natural fibers, chemical fibers, and mixtures thereof.

Preferred examples of the natural fibers include silk, cotton, and wool. Examples of the chemical fibers include synthetic fibers, regenerated fibers, and semi-synthetic fibers. Preferred examples of the synthetic fibers include polyester fibers, nylon fibers, acrylic fibers, polyurethane fibers, polyethylene fibers, polypropylene fibers, and vinylon fibers. Preferred examples of the regenerated fibers include rayon. Preferred examples of the semi-synthetic fibers include acetate and triacetate.

Among these, the fabric containing cotton, a polyester fiber, and a polypropylene fiber is preferred. A preferred heating treatment temperature varies depending on the type of the fiber constituting the fabric. If the clear ink or the ink set of the present invention is used in a fabric containing a polyester fiber as a main component or a fabric containing a polypropylene fiber as a main component, which has a low heating treatment temperature, a textile printed item with more excellent fastness to rubbing can also be produced. Furthermore, also in the case of the fabric such as cotton, which is subjected to a heating treatment at 160° C. to fix an image and ensures fastness in the related art, by using the clear ink or the ink set of the present invention, it is also possible to produce an image printed item with more excellent fastness to rubbing by a treatment at a lower heating temperature.

### 4. Method for Producing Image Printed Item

The present disclosure also provides a method for producing an image printed item including a fabric and an image including a clear ink layer and a color ink layer, in which an ink set for inkjet textile printing includes a clear ink for inkjet textile printing including resin emulsion particles, an oxazoline group-containing compound, and an aqueous medium, where the average particle size of the resin emulsion particles is 150 nm or more, the content of the oxazoline group-containing compound is 0.5 mass % to 70 mass % with respect to 100 mass % of the resin emulsion particles, and a color ink for inkjet textile printing including a pigment, resin emulsion particles, and an aqueous medium; and the clear ink layer is formed by printing the clear ink in the ink set for inkjet textile printing on a part or the whole of the fabric, and the color ink layer is formed by printing the color ink in the ink set for inkjet textile printing on a part or the whole of the fabric. In the method for producing an image printed item, for example, by using the above clear ink as, for example, a base for the color ink layer, an image printed item excellent in performance such as texture and fastness, such as fastness to rubbing and fastness to washing, can be provided.

As the method for producing an image printed item of the present invention, various production methods can be used, and among these, a production method in which the clear ink and the color ink are directly applied to the fabric, a production method using a transfer paper substrate, and the like are preferred.

The production method in which the clear ink and the color ink are directly applied to the fabric includes an image forming step of forming the clear ink layer and the color ink layer, and this step includes a step of printing the above clear ink of the present invention on a part or the whole of the fabric and drying the applied clear ink as necessary to form the clear ink layer, and a step of printing the above color ink on a part or the whole of the fabric and drying the applied color ink as necessary to form the color ink layer.

An order of printing the clear ink and the color ink on the fabric is not particularly limited. The color ink may be printed followed by the clear ink, the clear ink may be printed followed by the color ink, or the clear ink and the color ink may be printed simultaneously.

It is preferable to perform a step of forming the clear ink layer first and then perform a step of forming the color ink layer, thereby producing an image printed item in which the clear ink layer and the color ink layer are formed in this order on the fabric. Drying may be performed at ordinary temperature or by heating.

A well-known method in the related art can be used as the production method using a transfer paper substrate (hereinafter, sometimes referred to as a transfer textile printing method). The transfer textile printing method includes a transfer paper producing step including a step of forming a clear ink layer by printing the above clear ink of the present invention on a part or the whole of the transfer paper substrate by an inkjet printer, and drying as necessary, and a step of forming a color ink layer by printing the color ink on a part or the whole of the above transfer paper substrate, and drying as necessary. The above transfer paper substrate includes, for example, paper and film (polymer film such as PET).

The above transfer paper substrate may have a release layer on at least one surface. For example, a release layer formed (laminated) on one surface of a polymer film may be used as the transfer paper substrate.

When the transfer paper substrate having the above release layer is used, it is preferable that an ink such as the clear ink or the color ink is printed on a side where the release layer is formed (laminated) (an ink layer such as a clear ink layer or a color ink layer is formed on the side where the release layer is formed (laminated)).

The transfer paper substrate has the release layer, so that it is easier to peel off the ink layer such as the clear ink layer and the color ink layer from the transfer paper substrate, and thus, the ink becomes easily transferred from the transfer paper substrate to the fabric. In addition, the transfer paper substrate has a release layer on a side opposite to the surface where the ink layer such as the clear ink layer and the color ink layer is formed, so that it is possible to prevent blocking between the transfer paper substrates, and blocking between laminates in which the ink layer such as the clear ink layer and the color ink layer is laminated on the transfer paper substrate, or between laminates in which an adhesive layer to be described later is further laminated on each of the laminates.

The above release layer is preferably a layer obtained by coating at least one surface of the transfer paper substrate, such as a polymer film, with a release agent. Examples of the release agent include a polyethylene wax-based release agent, a silicone-based release agent, and a fluorine-based release agent. A thickness of the release layer is not particularly limited, but is preferably 10 nm to 2 μm, and more preferably 30 nm to 2 μm.

The above transfer paper substrate may have an ink receiving layer, and for example, one in which an ink receiving layer is formed (laminated) on one surface of a polymer film may be used as the transfer paper substrate.

When the transfer paper substrate having the above ink receiving layer is used, it is preferable that an ink such as the clear ink or the color ink is printed on a side where the ink receiving layer is formed (laminated) (an ink layer such as a clear ink layer or a color ink layer is formed on the side where the ink receiving layer is formed (laminated)).

When the above transfer paper substrate has the ink receiving layer, a part or the whole of the color ink layer or a colored ink layer may be absorbed in the ink receiving layer.

The ink receiving layer can be formed by coating the transfer paper substrate, such as a polymer film, with a solution containing a resin for forming the ink receiving layer. Examples of the resin include (meth)acrylic-based resins such as (meth)acrylic acid ester resins and (meth)acrylic acid ester-styrene copolymer resins; olefin-based resins such as polyethylene resins and polypropylene resins; silicone resins; polyvinyl alcohol resins; and cellulose-based resins such as sodium carboxymethyl cellulose. A solution containing the resin for forming the ink receiving layer may further contain inorganic particles such as calcium carbonate and silica. A thickness of the ink receiving layer is not particularly limited, but is preferably 30 nm to 20 μm, and more preferably 100 nm to 10 μm.

The above transfer paper substrate may have the above release layer and the above ink receiving layer in this order, and for example, one in which a release layer and an ink receiving layer formed (laminated) in this order on one surface of a polymer film may be used as the transfer paper substrate. It is preferable that an ink such as the clear ink or the color ink is printed on the side where the release layer and the ink receiving layer are formed (laminated) in this order (an ink layer such as a clear ink layer or a color ink layer is formed on the side where the release layer and the ink receiving layer are formed (laminated) in this order).

The above transfer paper producing step may further include a step of forming an adhesive layer on a part or the whole of an uppermost surface of the transfer paper substrate (for example, on the color ink layer or the clear ink layer). The above adhesive layer is not particularly limited as long as a resin that melts when heated is contained. The method for forming the adhesive layer may be a well-known method in the related art, for example, a method of applying a liquid composition (adhesive layer forming composition) containing a dispersed resin emulsion that melts when heated to the uppermost surface of the transfer paper substrate and evaporating the solvent to form the adhesive layer. By including this step, an image including the color ink layer and the clear ink layer is transferred to the fabric via the adhesive layer, and it is possible to further improve the adhesion between the image and the fabric.

Drying may be performed at ordinary temperature or by heating. The method further includes a transferring step of superposing the transfer paper substrate produced by the transfer paper producing step on the fabric and applying heat and/or pressure to transfer the clear ink layer and the color ink layer formed on the transfer paper substrate to the fabric, and a peeling step of peeling off the transfer paper substrate from the fabric after the image including the clear ink layer and the color ink layer is transferred by the transferring step.

An order of printing the clear ink and the color ink on the above transfer paper substrate is not particularly limited. The color ink may be printed followed by the clear ink, the clear ink may be printed followed by the color ink, or the clear ink and the color ink may be printed simultaneously.

Preferably, the step of forming the color ink layer is performed first, and then the step of forming the clear ink layer is performed to form the color ink layer and the clear ink layer in this order on the transfer paper substrate, and preferably, an adhesive layer is further formed to produce transfer paper. Preferably, then, the above transferring step and the above peeling step are performed using the obtained transfer paper to produce an image printed item in which the clear ink layer and the color ink layer are formed in this order on the fabric.

The inkjet printer used in the image forming step in the production method in which the clear ink and the color ink are directly applied to the fabric, and used in the transfer paper producing step in the production method using the transfer paper substrate is not particularly limited, and any well-known inkjet printer in the related art may be used. The inkjet printer may be of any type, such as a piezoelectric type, a thermal type, or a charge change control type (continuous ejection type), and a piezoelectric type inkjet printer is particularly preferred. When the above piezoelectric type inkjet printer is used, protruding conditions of the clear ink and the color ink are not particularly limited. Selection may be appropriately performed depending on properties of the clear ink and the color ink, the type of the fabric, and the type of any image such as characters, pictures, and figures. Viscosities of the clear ink and the color ink are preferably each independently in a range of 2 mPa/s to 20 mPa/s. Surface tensions of the clear ink and the color ink are preferably each independently in a range of 25 mN/m to 45 mN/m.

In the image forming step and the transfer paper producing step, the clear ink and the color ink ejected from a nozzle opening of an inkjet printer head are attached to the surface of the fabric and the transfer paper substrate, respectively, to form the clear ink layer and the color ink layer, and an image printed item having an image including these layers is obtained.

The method for producing an image printed item of the present invention preferably includes a step (also referred to as a heating (drying) treatment step) of heating (drying) the fabric where the clear ink layer and the color ink layer are formed in the image forming step at a temperature higher than room temperature. In addition, the transfer textile printing method preferably includes a step (also referred to as a heating (drying) treatment step) of heating (drying) the fabric to which the image is transferred from the transfer paper substrate in the transferring step at a temperature higher than the room temperature. According to the heating treatment at a temperature higher than the room temperature, the removal of volatile components such as aqueous media derived from the clear ink and color ink contained in the clear ink layer and color ink layer can be further promoted, and the fixation of the image can be further promoted. In addition, the adhesion and the like of the image can be further improved by the film formation (fusion) of the resin emulsion particles contained in the clear ink and color ink. In addition, the reaction of generating the reaction products (C) and (C′) is also more likely to proceed.

The heating treatment step may be performed simultaneously with the image forming step or the transferring step, or may be performed after the image forming step or the transferring step. The two may also be combined. Examples of a method of performing the heating treatment step simultaneously with the image forming step or the transferring step include a method of performing the image forming step or the transferring step while heating the fabric. Examples of a heating treatment method where the heating treatment step is performed after the image forming step or the transferring step preferably include a heating method using a heating and drying oven, a heating method using a heat press, a heating method using an infrared lamp, and a method using steam such as normal pressure steam or high pressure steam. Among these, the heating method is preferably performed after the image forming step or the transferring step because there is a risk of disturbing the air flow if these steps are performed simultaneously.

The heating temperature in the above heating treatment step is preferably 90° C. to 180° C. An upper limit is more preferably 150° C. or lower, furthermore preferably 130° C. or lower, and particularly preferably 120° C. or lower, and a lower limit is more preferably 95° C. or higher, and furthermore preferably 100° C. or higher. In the heating treatment step, recommended heating temperature and time vary depending on a fiber constituting the fabric. For example, the recommended heating temperature is 160° C. for cotton, is 125° C. for polypropylene, and is 110° C. for polyester, and the time for each is 5 minutes or less, preferably 3 minutes or less, and more preferably 2 minutes or less. The textile printed item (image printed item including the fabric and the image) obtained after the above heating treatment step may be washed with water and dried.

According to the method for producing an image printed item of the present invention using the ink set for inkjet textile printing of the present invention and the above transfer textile printing method, it is possible to produce a textile printed item (image printed item including the fabric and the image) excellent in fastness to rubbing of the image including the formed clear ink layer and the formed color ink layer, in an energy-saving and environmentally friendly manner, preferably even at a low heating temperature.

In order to obtain a textile printed item having excellent fastness to rubbing in a short time, the heating temperature is preferably 90° C. or higher as described above. However, the heating temperature in the heating treatment step is not limited to the above range, and may be, for example, a temperature near ordinary temperature, for example, 15° C. to 25° C. Even at such a temperature, the fastness to rubbing of the image including the formed clear ink layer and the formed color ink layer can be further improved by heating for a long time. From a viewpoint of shortening the heating time, 30° C. or higher is preferred, 50° C. or higher is more preferred, and 90° C. or higher is furthermore preferred.

Here, the ordinary temperature is, for example, 15° C. to 25° C., and the room temperature is an actual temperature in a room, which is usually considered to be about 15° C. to 25° C.

The present disclosure also provides an inkjet textile printing method using the clear ink including the resin emulsion particles, the oxazoline group-containing compound, and the aqueous medium, in which the average particle size of the resin emulsion particles is 150 nm or more, and the content of the oxazoline group-containing compound is 0.5 mass % to 70 mass % with respect to 100 mass % of the resin emulsion particles. In the inkjet textile printing method, for example, by using the above clear ink as a base for the color ink layer, an image printed item having excellent performance such as texture and fastness such as, fastness to rubbing and fastness to washing, can be provided.

The inkjet textile printing method is particularly suitable for a textile printing method of directly applying an ink to a fabric or a textile printing method using a transfer paper substrate.

Suitable aspects in the clear ink used in the inkjet textile printing method (for example, the average particle size of the resin emulsion particles and the content of the oxazoline group-containing compound) are each independently the same as the suitable aspects described above for the clear ink for inkjet textile printing of the present invention (for example, the average particle size of the resin emulsion particles and the content of the oxazoline group-containing compound).

The inkjet textile printing method is not particularly limited other than the use of the clear ink. Examples of the inkjet textile printing method include a textile printing method of directly applying an ink to a fabric and a textile printing method using a transfer paper substrate, and suitable aspects thereof (for example, type of the inkjet printer, heating method and temperature in the heating treatment step, printing method in the textile printing method of directly applying an ink to a fabric, and a form of the transfer paper substrate and specific method in the transfer paper producing step in the textile printing method using the transfer paper substrate) are independently the same as the suitable aspects described in the section on the method for producing an image printed item of the present invention (for example, type of the inkjet printer, heating method and temperature in the heating treatment step, printing method in the textile printing method of directly applying an ink to a fabric, and a form of the transfer paper substrate and specific method in the transfer paper producing step in the textile printing method using the transfer paper substrate).

The present disclosure also provides a use, in inkjet textile printing, of the clear ink including the resin emulsion particles, the oxazoline group-containing compound, and the aqueous medium, in which the average particle size of the resin emulsion particles is 150 nm or more, and the content of the oxazoline group-containing compound is 0.5 mass % to 70 mass % with respect to 100 mass % of the resin emulsion particles. According to the use of the clear ink in the inkjet textile printing, for example, by using the above clear ink as a base for the color ink layer, an image printed item having excellent performance such as texture and fastness, such as fastness to rubbing and fastness to washing, can be provided.

The use of the clear ink in the inkjet textile printing is particularly suitable for a textile printing method of directly applying an ink to a fabric or a textile printing method using a transfer paper substrate.

Suitable aspects of the clear ink in the use of the clear ink in the inkjet textile printing (for example, the average particle size of the resin emulsion particles and the content of the oxazoline group-containing compound) are each independently the same as the suitable aspects described for the above clear ink for inkjet textile printing of the present invention (for example, the average particle size of the resin emulsion particles and the content of the oxazoline group-containing compound), and suitable aspects of the textile printing method (for example, type of the inkjet printer, heating method and temperature in the heating treatment step, printing method in the textile printing method of directly applying an ink to a fabric, and a form of the transfer paper substrate and specific method in the transfer paper producing step in the textile printing method using the transfer paper substrate) are independently same as the suitable aspects described in the section on the above method for producing an image printed item of the present invention (for example, type of the inkjet printer, heating method and temperature in the heating treatment step, printing method in the textile printing method of directly applying an ink to a fabric, and a form of the transfer paper substrate and specific method in the transfer paper producing step in the textile printing method using the transfer paper substrate).

### EXAMPLES

The present invention will be described in more detail below with reference to examples, but the present invention is not limited to these examples. Unless otherwise specified, “part” means “part by mass” and “%” means “mass %”.

A measurement method and an evaluation method are as follows.

### <Average Particle Size of Resin Emulsion Particles>

An average particle size of resin emulsion particles used is a value obtained by a cumulant method when a resin emulsion was measured using a particle size distribution measuring device (manufactured by Otsuka Electronics Co., Ltd., product number: FPAR-1000) based on a dynamic light scattering method.

### <Weight Average Molecular Weight of Resin Emulsion Particles>

A weight average molecular weight of the resin emulsion particles used is a value obtained by a weight average molecular weight (in terms of polystyrene) when the resin emulsion was measured using gel permeation chromatography (manufactured by Tosoh Corporation, product number: HLC-8120GPC, column: TSKgel G-5000HXL and TSKgel GMHXL-L used in series).

### <Average Particle Size of Pigment>

An average particle size of a pigment used is a value obtained by a cumulant method when a pigment dispersion was measured using a particle size distribution measuring device (manufactured by Otsuka Electronics Co., Ltd., product number: FPAR-1000) based on a dynamic light scattering method.

### <Viscosity of Ink>

Each of clear inks produced in Examples and Comparative Examples, and each of the color inks such as a cyan ink and a white ink produced in Production Examples were measured using an E-type viscometer TPE-100 (manufactured by Toki Sangyo Co., Ltd.) under the conditions of rotor R24, 0.8 degrees, and 25° C.

### <Storage Stability of Ink>

The storage stability of each of the clear inks produced in Examples and Comparative Examples was evaluated as follows. Each of the clear inks produced in Examples and Comparative Examples was enclosed in a sealed vessel and stored in a thermostatic chamber at 50° C. for 30 days, and was evaluated in accordance with the following evaluation criteria.
A: A viscosity change rate before and after storage is less than 5%.
B: A viscosity change rate before and after storage is 5% to 10%.
C: A viscosity change rate before and after storage is 11% to 20%.
D: Gelled due to storage.

### <Ejection Stability>

An ejection stability of each of the clear inks produced in Examples and Comparative Examples was evaluated as follows. Each of the clear inks produced in Examples and Comparative Examples was introduced into a textile printer MMP-TX13 manufactured by Mastermind Co., Ltd., and was subjected to a nozzle check printing (in which ruled lines were printed by ejecting the ink in sequence from all the 180 nozzles) on a PET film, and the print was visually evaluated for scattering (deflection) and missing dots. The head was further capped and left to stand still for one week, and then a nozzle check printing was performed again, and the print was visually evaluated for scattering (deflection) and missing dots.
A: No scattering (deflection) and no missing dot in initial printing and after-one-week printing.
B: One or two scatterings (deflections) or missing dots in the greater of the initial printing and the after-one-week printing.
C: Three or four scatterings (deflections) or missing dots in the greater of the initial printing and the after-one-week printing.
D: Five or more scatterings (deflections) or missing dots in the greater of the initial printing and the after-one-week printing.

### <Fastness to Rubbing>

Each of image printed items obtained in Examples and Comparative Examples was subjected to a dry rubbing test and a wet rubbing test with a load of 200 g and 100 reciprocations by using a type II testing machine having attached white cloth of cotton No. 3-1 in accordance with a method specified in JIS L0849, and then the fastness to rubbing of the image printed item was evaluated with a discoloration and fading gray scale. Note that for Examples using the white ink (for example, Examples 2-11, 2-12, and 2-13), the ink was printed on a cotton fabric (a 100% cotton black T-shirt manufactured by Hanes, Inc.) and the fabric was evaluated.
A: Grade 4-5 or higher grade in both the dry rubbing test and the wet rubbing test.
B: Grade 3-4 to grade 4 in both the dry rubbing test and the wet rubbing test.
C: Grade 2-3 to grade 3 in both the dry rubbing test and the wet rubbing test.
D: Grade 2 or lower grade in either of the dry rubbing test and the wet rubbing test.

### <Fastness to Washing>

Each of the image printed items obtained in Examples and Comparative Examples was subjected to ordinary washing ten times with a domestic washing machine (washing conditions: washing in normal mode→rinsing→dehydration→drying, liquid detergent Ariel (manufactured by P&G Co.) was used), was evaluated for a degree of fading with a discoloration and fading gray scale.
A: Grade 4-5 to grade 5.
B: Grade 3-4 to grade 4.
C: Grade 2-3 to grade 3.
D: Grade 2 or lower grade.

### <Texture>

Each of the image printed items obtained in Examples and Comparative Examples was evaluated by touch.
A: The image printed item readily bent and had softness close to that of an original fabric.
B: The image printed item readily bent but felt slightly stiffer than the original fabric.
C: The image printed item felt stiff.
D: The image printed item was too hard to bend freely.

### <Emulsion Production Examples>

### Emulsion Production Example 1

Two hundred and fifty-two parts of deionized water were introduced into a flask including a dropping funnel, a stirrer, a nitrogen introduction tube, a thermometer, and a reflux condenser. A pre-emulsion for dropping composed of 437 parts of deionized water, 80 parts of 25% aqueous solution of an emulsifier (manufactured by ADEKA Corporation, trade name: ADEKA REASOAP SR-10), 25 parts of acrylic acid, 565 parts of 2-ethylhexyl acrylate, 50 parts of cyclohexyl methacrylate, 10 parts of hydroxyethyl methacrylate, and 350 parts of styrene was prepared in the dropping funnel, and 44 parts of the pre-emulsion, which corresponded to 3% of all the monomer components, was introduced into the flask, while nitrogen gas was being gently fed thereinto, a temperature was raised to 80° C., and 30 parts of 5% aqueous ammonium persulfate solution was added to initiate polymerization. Thereafter, a remainder of the pre-emulsion for dropping and 30 parts of 5% aqueous ammonium persulfate solution were evenly dropped into the flask over 240 minutes. After completion of the dropping, contents of the flask were held at 80° C. for 180 minutes, and 25% ammonia water and deionized water were added thereto to thereby adjust a pH to 8.5 and a solid content to 50%, and the polymerization was ended. The obtained reaction liquid was cooled to room temperature and then filtered with a 300-mesh metal sieve, thereby obtaining an emulsion. The emulsion resin particles had a styrene-based monomer content of 35% and a Tg of −21° C., and a particle size of the emulsion was 200 nm. A weight average molecular weight of the emulsion resin particle was 750000.

### Emulsion Production Example 2

An emulsion was obtained in the same manner as in Emulsion Production Example 1, except that 7 parts of the pre-emulsion for dropping, which corresponded to 0.5% of all the monomer components in Emulsion Production Example 1, were introduced into the flask. The emulsion resin particles had a styrene-based monomer content of 35% and a Tg of −21° C., and a particle size of the emulsion was 310 nm. A weight average molecular weight of the emulsion resin particle was 1000000.

### Emulsion Production Example 3

An emulsion was obtained in the same manner as in Emulsion Production Example 1, except that 87 parts of the pre-emulsion for dropping, which corresponded to 6% of all the monomer components in Emulsion Production Example 1, were introduced into the flask. The emulsion resin particles had a styrene-based monomer content of 35% and a Tg of −21° C., and an average particle size of the emulsion was 140 nm. A weight average molecular weight of the emulsion resin particle was 750000.

### PIGMENT DISPERSION PRODUCTION EXAMPLES

### Pigment Dispersion Production Example 1

Three parts of dispersant Joncryl 678 (manufactured by BASF A.G.), 1.3 parts of dimethylaminoethanol, and 81 parts of deionized water were stirred and mixed at 70° C. Next, 15 parts of blue pigment C.I. Pigment Blue 15:3 LIONOL BLUE FG-7330 (manufactured by Toyo Ink Mfg. Co., Ltd.) and 0.1 parts of surfactant Olfine D-10PG (manufactured by Nissin Chemical Industry Co., Ltd.) were dispersed with a bead mill using zirconia beads with a particle size of 0.5 mm filled in an amount of 50% in terms of volume proportion, and the resultant mixture was filtered with a filter having a pore diameter of 1 μm (MCP-1-C10S, manufactured by Advantec Co., Ltd.), thereby obtaining a blue-pigment dispersion having a pigment content of 15%. An average particle size was 90 nm.

### Pigment Dispersion Production Example 2

Five parts of dispersant Discoat N-14 (manufactured by Dai-ichi Kogyo Seiyaku Co., Ltd.), 6 parts of propylene glycol, 70 parts of deionized water, and 100 parts of titanium oxide CR-95 (manufactured by Ishihara Sangyo Kaisha, Ltd.) were dispersed with a bead mill using zirconia beads with a particle size of 0.5 mm filled in an amount of 50% in terms of volume proportion, thereby obtaining a white-pigment dispersion having a pigment content of 55%. An average particle size was 330 nm.

### <Production and Evaluation of Clear Ink>

### Example 1-1

Thirty parts (15 parts in terms of emulsion particle) of the emulsion obtained in Emulsion Production Example 1, 1.2 parts (0.3 parts in terms of solid) of Epocros WS-700 (manufactured by Nippon Shokubai Kagaku Kogyo Co., Ltd., solid content: 25%), 2 parts of diethylene glycol monobutyl ether, 15 parts of triethylene glycol, 0.3 parts of silicone surfactant KF-6011 (manufactured by Shin Etsu Chemical Co., Ltd.) as a leveling agent, 0.3 parts of acetylene surfactant Olfine D-10PG (manufactured by Nissin Chemical Industry Co., Ltd.) as the leveling agent similarly, and 51 parts of deionized water were mixed, and the mixture was filtered with a filter having a pore diameter of 1 μm (MCP-1-C10S, manufactured by Advantec Co., Ltd.), thereby producing a clear ink (1).

### Examples 1-2 to 1-7 and Comparative Examples 1-1 to 1-4

Clear inks (2) to (11) were produced in the same manner as in Example 1-1, except that the types and feed amounts of the materials in Example 1-1 were changed as shown in Table 1 and that the feed amount of deionized water was adjusted so as to achieve a total amount of 100 parts. In producing the clear ink (11), a urethane resin emulsion A: Takelac W6110 (manufactured by Mitsui Chemicals, Inc., solid content 30%) was used as the emulsion.

Table 1 shows physical properties of the clear inks obtained in the above Examples and Comparative Examples.

TABLE 1

| | | | | | | | | Compar- | Compar- | Compar- | Compar- |
|---|---|---|---|---|---|---|---|---|---|---|---|
| | | | | | | | | ative | ative | ative | ative |
| | Exam- | Exam- | Exam- | Exam- | Exam- | Exam- | Exam- | Exam- | Exam- | Exam- | Exam- |
| | ple 1-1 | ple 1-2 | ple 1-3 | ple 1-4 | ple 1-5 | ple 1-6 | ple 1-7 | ple 1-1 | ple 1-2 | ple 1-3 | ple 1-4 |
| | Clear | Clear | Clear | Clear | Clear | Clear | Clear | Clear | Clear | Clear | Clear |
| | ink 1 | ink 2 | ink 3 | ink 4 | ink 5 | ink 6 | ink 7 | ink 8 | ink 9 | ink 10 | ink 11 |
| <Resin emulsion> | | | | | | | | | | | |
| Emulsion Production | 1 | 1 | 1 | 2 | 1 | 1 | 1 | 1 | 1 | 3 | |
| Example | | | | | | | | | | | |
| Urethane emulsion | | | | | | | | | | | A |
| Particle size (nm) | 200 | 200 | 200 | 310 | 200 | 200 | 200 | 200 | 200 | 140 | 60 |
| <Contents (mass %) of | | | | | | | | | | | |
| components with respect | | | | | | | | | | | |
| to 100 mass % of ink> | | | | | | | | | | | |
| Resin emulsion particle | 15 | 15 | 15 | 15 | 11 | 15 | 15 | 15 | 10 | 15 | 15 |
| Oxazoline group- | 0.3 | 0.1 | 0.6 | 0.3 | 0.2 | 0.3 | 0.3 | — | 8 | 0.3 | 0.3 |
| containing compound | | | | | | | | | | | |
| KF-6011 | 0.3 | 0.3 | 1.5 | 0.3 | 0.3 | — | 0.3 | 0.3 | 0.3 | 0.3 | 0.3 |
| Olfine D-10PG | 0.3 | 0.3 | 0.3 | 0.3 | 0.3 | 0.3 | — | 0.3 | 0.3 | 0.3 | 0.3 |
| <Blending ratio> | | | | | | | | | | | |
| Oxazoline group- | 2.0 | 0.7 | 10.0 | 2.0 | 2.0 | 2.0 | 2.0 | 0.0 | 80.0 | 2.0 | 2.0 |
| containing compound/resin | | | | | | | | | | | |
| emulsion particle (mass %) | | | | | | | | | | | |
| <Physical properties | | | | | | | | | | | |
| of ink> | | | | | | | | | | | |
| Viscosity (mPa · s) | 4 | 4 | 4 | 4 | 4 | 4 | 4 | 3 | 6 | 6 | 6 |

### COLOR INK PRODUCTION EXAMPLES

### Cyan Ink Production Example 1

Thirty parts (15 parts in terms of emulsion particle) of the emulsion in Emulsion Production Example 1, 23 parts (3.5 parts in terms of pigment) of the pigment dispersion in Pigment Dispersion Production Example 1, 2 parts of diethylene glycol monobutyl ether, 15 parts of triethylene glycol, 0.3 parts of silicone surfactant KF-6011 (manufactured by Shin Etsu Chemical Co., Ltd.), 0.3 parts of acetylene surfactant Olfine D-10PG (manufactured by Nissin Chemical Industry Co., Ltd.), and 29.5 parts of deionized water were mixed, and the mixture was filtered with a filter having a pore diameter of 1 μm (MCP-1-C10S, manufactured by Advantec Co., Ltd.), thereby producing a cyan ink (1).

### Cyan Ink Production Examples 2 to 3 and White Ink Production Examples 1 to 3

Cyan inks (2) to (3) and white inks (1) to (3) were produced in the same manner as in Cyan Ink Production Example 1, except that the types and feed amounts of the materials in Cyan Ink Production Example 1 were changed as shown in Table 2 and that the feed amount of deionized water was adjusted so as to achieve a total amount of 100 parts. In producing the cyan ink (3) and the white ink (3), a urethane resin emulsion A: Takelac W6110 (manufactured by Mitsui Chemicals, Inc., solid content 30%) was used as the emulsion.

TABLE 2

| | Cyan ink 1 | Cyan ink 2 | Cyan ink 3 | White ink 1 | White ink 2 | White ink 3 |
|---|---|---|---|---|---|---|
| <Resin emulsion> | | | | | | |
| Emulsion Production Example | 1 | 1 | | 1 | 1 | |
| Urethane emulsion | | | A | | | A |
| Particle size (nm) | 200 | 200 | 60 | 200 | 200 | 60 |
| <Pigment> | | | | | | |
| Pigment dispersion | 1 | 1 | 1 | 2 | 2 | 2 |
| <Contents (mass %) of components with | | | | | | |
| respect to 100 mass % of ink> | | | | | | |
| Pigment | 3.5 | 3.5 | 3.5 | 15 | 15 | 15 |
| Resin emulsion particles | 15 | 15 | 10 | 11 | 11 | 6 |
| Oxazoline group-containing compound | — | 0.3 | 0.2 | — | 0.2 | 0.1 |
| KF-6011 | 0.3 | 0.3 | 0.3 | 0.3 | 0.3 | 0.3 |
| Olfine D-10PG | 0.3 | 0.3 | 0.3 | 0.3 | 0.3 | 0.3 |
| <Blending ratio> | | | | | | |
| Oxazoline group-containing compound/resin | 0 | 2.0 | 2.0 | 0 | 1.8 | 1.7 |
| emulsion particles (mass %) | | | | | | |
| <Physical properties of ink> | | | | | | |
| Viscosity (mPa · s) | 4 | 5 | 7 | 5 | 6 | 8 |

### <Production of Image Printed Item>

### Example 2-1

The clear ink (1) and the cyan ink (1) obtained above were introduced into a textile printer MMP-TX13 manufactured by Mastermind Co., Ltd. Solid printing was conducted with the clear ink (1) on a cotton fabric (cotton-100% white T-shirt manufactured by Hanes. Inc.) under conditions of 1440 dpi×1440 dpi, set printing speed 8, and 120 mm×120 mm, thereby printing the clear ink on the fabric. Thereafter, solid printing was subsequently conducted with the cyan ink (1) on a region where a clear ink layer was formed under conditions of 1440 dpi×1440 dpi, set printing speed 8, and 110 mm×110 mm, thereby printing an image. The fabric printed with the clear ink (1) and the cyan ink (1) was subjected to a heating treatment for 90 seconds in a hot air dryer at 110° C. to obtain an image printed item (1) having an image in which the clear ink layer and a color ink layer were formed in this order on the fabric.

### Examples 2-2 to 2-13 and Comparative Examples 2-1 to 2-5

Except that instead of the clear ink (1) and the cyan ink (1) in Example 2-1, the clear inks obtained in Examples 1-2 to 1-7 and Comparative Examples 1-1 to 1-4 and the color inks produced in the above Color Ink Production Examples were used as shown in Tables 3 and 4, the printing based on the inkjet method was performed in the same manner as in Example 2-1, and image printed items (2) to (13) of Examples and image printed items (c1) to (c5) of Comparative Examples in which a clear ink layer and a color ink layer were formed on the fabric in that order were obtained. The types of fabrics used in Examples and Comparative Examples are as shown in Tables 3 and 4. The polyester fabric used was 100% polyester white T-shirt fabric manufactured by Gunze Co., Ltd.

Tables 3 and 4 show evaluation results of the clear inks obtained in Examples and Comparative Examples, and evaluation results of the image printed items.

TABLE 3

| | Example | | | | | | | | | | | | |
|---|---|---|---|---|---|---|---|---|---|---|---|---|---|
| | 2-1 | 2-2 | 2-3 | 2-4 | 2-5 | 2-6 | 2-7 | 2-8 | 2-9 | 2-10 | 2-11 | 2-12 | 2-13 |
| <Ink set> | | | | | | | | | | | | | |
| Clear ink | 1 | 1 | 2 | 3 | 4 | 5 | 6 | 7 | 1 | 1 | 1 | 1 | 1 |
| Cyan ink | 1 | 1 | 1 | 1 | 1 | 1 | 1 | 1 | 2 | 3 | | | |
| White ink | | | | | | | | | | | 1 | 2 | 3 |
| <Image formation> | | | | | | | | | | | | | |
| Fabric | Cotton | Polyester | Cotton | Cotton | Cotton | Cotton | Cotton | Cotton | Cotton | Cotton | Cotton | Cotton | Cotton |
| <Evaluation of clear | | | | | | | | | | | | | |
| ink> | | | | | | | | | | | | | |
| Storage stability | A | A | A | A | A | A | A | A | A | A | A | A | A |
| Ejection stability | A | A | A | A | A | A | B | B | A | A | A | A | A |
| <Evaluation of printed | | | | | | | | | | | | | |
| item> | | | | | | | | | | | | | |
| Fastness to rubbing | B | B | B | B | B | B | B | B | A | C | B | A | C |
| Fastness to washing | A | A | B | A | A | B | B | B | A | C | A | A | C |
| Texture | B | B | B | B | B | B | B | B | B | B | B | B | B |

TABLE 4

| | Comparative | Comparative | Comparative | Comparative | Comparative |
|---|---|---|---|---|---|
| | Example 2-1 | Example 2-2 | Example 2-3 | Example 2-4 | Example 2-5 |
| <Ink set> | | | | | |
| Clear ink | — | 8 | 9 | 10 | 11 |
| Cyan ink | 1 | 1 | 1 | 1 | 1 |
| <Image formation> | | | | | |
| Fabric | Cotton | Cotton | Cotton | Cotton | Cotton |
| <Evaluation of clear ink> | | | | | |
| Storage stability | — | A | D | C | D |
| Ejection stability | — | A | C | D | C |
| <Evaluation of printed item> | | | | | |
| Fastness to rubbing | D | D | C | C | C |
| Fastness to washing | D | D | D | C | C |
| Texture | B | B | B | B | B |

As shown in Table 3, regarding each of the image printed items using the ink sets of Examples 2-1 to 2-13, storage stability and the ejection stability of the clear ink were evaluated as excellent, such as B to A, and performance such as texture and fastness, such as fastness to rubbing and fastness to washing, were evaluated as good, such as C to A.

### INDUSTRIAL APPLICABILITY

The clear ink for inkjet textile printing of the present invention has excellent storage stability as an ink and excellent ejection stability during printing, and can provide an image printed item having excellent performance such as texture and fastness, such as fastness to rubbing and fastness to washing, in a textile printing method using an inkjet method.

1. A clear ink for inkjet textile printing comprising:
resin emulsion particles;
an oxazoline group-containing compound; and
an aqueous medium, wherein
an average particle size of the resin emulsion particles is 150 nm or more, and
a content of the oxazoline group-containing compound is 0.5 mass % to 70 mass % with respect to 100 mass % of the resin emulsion particles.

2. An ink set for inkjet textile printing comprising:
the clear ink for inkjet textile printing according to claim 1; and
a color ink for inkjet textile printing that contains a pigment, resin emulsion particles, and an aqueous medium.

3. An image printed item comprising:
a fabric; and
an image including:
a clear ink layer formed by printing the clear ink in the ink set for inkjet textile printing according to claim 2 on a part or the whole of the fabric; and
a color ink layer formed by printing the color ink in the ink set for inkjet textile printing according to claim 2 on a part or the whole of the fabric.

4. The image printed item according to claim 3, wherein
the clear ink layer and the color ink layer are formed in this order on the fabric.

5. The clear ink for inkjet textile printing according to claim 1, wherein the average particle size of the resin emulsion particles is 350 nm or less.

6. The clear ink for inkjet textile printing according to claim 1, wherein a glass transition temperature of the resin emulsion particles is 0° C. or lower.

7. The clear ink for inkjet textile printing according to claim 1, wherein the resin emulsion particles have an acidic functional group.

8. The clear ink for inkjet textile printing according to claim 7, wherein a structural unit derived from a monomer having the acidic functional group with respect to 100 mass % of the resin emulsion particles is 0.1 mass % to 5 mass %.

9. The clear ink for inkjet textile printing according to claim 1, wherein an acid value of the resin emulsion particles is 0.5 mgKOH/g to 50 mgKOH/g.

10. The clear ink for inkjet textile printing according to claim 1, wherein a weight average molecular weight of a resin component constituting the resin emulsion particles is 50000 or more.

11. The clear ink for inkjet textile printing according to claim 1, wherein the resin emulsion particles comprise an acrylic-styrene-based polymer as a resin constituting the resin emulsion particles.

12. The clear ink for inkjet textile printing according to claim 11, wherein the acrylic-styrene-based polymer is a polymer having a carboxy group.

13. The clear ink for inkjet textile printing according to claim 11, wherein a content of the acrylic styrene-based polymer in the resin emulsion particles is 85 mass % to 100 mass %.

14. The clear ink for inkjet textile printing according to claim 1, wherein the oxazoline group-containing compound is a water-soluble oxazoline group-containing compound or an oxazoline group-containing polymer.

15. The clear ink for inkjet textile printing according to claim 1, wherein the oxazoline group-containing compound is a water-soluble oxazoline group-containing polymer.

16. The clear ink for inkjet textile printing according to claim 1, wherein a content of the resin emulsion particles is 10 mass % to 20 mass % with respect to 100 mass % of the clear ink.

17. The clear ink for inkjet textile printing according to claim 1, further comprising at least one selected from the group consisting of an acetylene-based surfactant, a silicone-based surfactant, and a fluorine-based surfactant.

18. A method for producing an image printed item comprising:
printing the clear ink in the ink set for inkjet textile printing according to claim 2 on a part or the whole of a fabric to form a clear ink layer, and
printing the color ink in the ink set for inkjet textile printing according to claim 2 on a part or the whole of the fabric to form a color ink layer.
